(19) United States
(12) Patent Application Publication
(10) Pub. No.: US 2024/0391406 A1
(43) Pub. Date: Nov. 28, 2024

(54) AIRBAG DEPLOYMENT CONTROL SYSTEM AND AIRBAG DEPLOYMENT CONTROL METHOD

(71) Applicants: Hyundai Motor Company, Seoul (KR); Kia Corporation, Seoul (KR); Hyundai Mobis Co., Ltd., Seoul (KR)

(72) Inventors: Yoon Im, Suwon (KR); Chang Il Sung, Hwaseong (KR); Ji Yun Ha, Suwon (KR); Dae Hee Lee, Incheon (KR); Sang Won Hwangbo, Yongin (KR)

(21) Appl. No.: 18/517,034

(22) Filed: Nov. 22, 2023

(30) Foreign Application Priority Data
May 22, 2023 (KR) 10-2023-0065684

(51) Int. Cl. B60R 21/015; B60R 21/013

(52) U.S. Cl. CPC B60R 21/01512; B60R 21/013; B60R 2021/0004; B60R 2021/0006; B60R 2021/0009; B60R 2021/01245; B60R 21/01554; B60R 2021/23107

(57) ABSTRACT

An airbag deployment control system and an airbag deployment control method are capable of handling various collision modes by optimally restraining a passenger in various seat positions, and the airbag deployment control system includes airbag cushions provided for each seat and configured to be deployed in shapes that cover a lateral surface and a front surface of the seat at left or right sides of the seat, and a controller configured to perform control to selectively deploy the left or right airbag cushions for each of the seats depending on a collision direction of a vehicle, whether a passenger is seated in the seat, and a seat direction.

### CROSS REFERENCE TO RELATED APPLICATION

The present application claims under 35 U.S.C. § 119 (a) the benefit of Korean Patent Application No. 10-2023-0065684, filed on May 22, 2023, the entire contents of which are incorporated by reference herein.

### BACKGROUND

### (a) Technical Field

The present disclosure relates to an airbag deployment control system and an airbag deployment control method that are operable to handle various collision modes by optimally restraining a passenger in various seat positions.

### (b) Description of the Related Art

Autonomous vehicles typically are arranged with seats in various positions such as relaxing positions, swiveling positions, and seat positions that allow passengers to be seated to face one another. Therefore, it is necessary to cope with collision situations occurring in various ways.

However, airbags in the related art typically cannot directly restrain passengers, which causes a problem in which the airbags cannot cope with various collision modes.

Therefore, there is a need to improve airbag deployment to effectively protect the passenger in various collision situations and various seat positions. To this end, airbags with various concepts have been developed.

Increasing the number of airbags or adding novel airbags may assist in protecting the passengers. However, it is difficult to ensure a space for mounting the airbag, and the addition of an airbag causes increases in costs and weight, which makes it difficult to apply the additional airbag to actual vehicles.

The foregoing explained as the background is intended merely to aid in the understanding of the background of the present disclosure, and is not intended to mean that the present disclosure falls within the purview of the related art that is already known to those skilled in the art.

### SUMMARY

The present disclosure provides an airbag deployment control system and an airbag deployment control method that are capable of handling various collision modes by optimally restraining a passenger in various seat positions.

To achieve the above-mentioned object, the present disclosure provides an airbag deployment control system including: a plurality airbag cushions provided for a seat and configured to be deployed in shapes that cover a lateral surface and a front surface of the seat at left and right sides of the seat; and a controller configured to perform control to selectively deploy at least one of left and right airbag cushions among the plurality of airbag cushions for the seat depending on a collision direction of a vehicle, whether a passenger is seated in the seat, and a seat direction.

The airbag deployment control system may include an additional seat and an additional plurality of airbag cushions configured to be deployed with respect to the additional seat.

The vehicle may include a plurality of seats, each of the seats having a respective plurality of airbag cushions arranged with respect to a respective one of the plurality of seats.

The controller may perform control to deploy the left and right airbag cushions in the seat in which the passenger is seated in the event of a head-on collision of the vehicle regardless of the seat direction.

The controller may perform control to deploy the left and right airbag cushions in the seat in which the passenger is seated in the event of a frontal broadside oblique collision of the vehicle regardless of the seat direction.

The controller may perform control to deploy only the airbag cushions in the seat in which the passenger is seated and to selectively deploy the left and right airbag cushions depending on the collision direction and the direction of the seat in which the passenger is seated when the passenger is seated only in one side seat in the event of a broadside collision of the vehicle.

The controller may perform control to deploy only the airbag cushions in a direction in which a collision occurs among the left and right airbag cushions in the seat in which the passenger is seated in the event of a broadside collision of the vehicle when the passenger is seated only in one side seat and the direction of the seat in which the passenger is seated is directed forward or rearward.

The controller may perform control to deploy the right airbag cushion in the event of a broadside collision of the vehicle when the passenger is seated only in one side seat, the direction of the seat in which the passenger is seated is directed toward the inside of the vehicle, and the collision occurs in one direction.

The controller may perform control to deploy the left airbag cushion in the event of a broadside collision of the vehicle when the passenger is seated only in one side seat, the direction of the seat in which the passenger is seated is directed toward the inside of the vehicle, and the collision occurs in the other direction.

The controller may perform control to deploy the left and right airbag cushions in the seat in which the passenger is seated in the event of a broadside collision of the vehicle when the passenger is seated only in one side seat and the direction of the seat in which the passenger is seated is directed toward the outside of the vehicle.

The controller may perform control to deploy the left and right airbag cushions in the seat positioned in the collision direction regardless of the seat direction when the passengers are seated in two opposite seats in the event of a broadside collision of the vehicle.

The controller may perform control to deploy only the airbag cushions in the collision direction among the left and right airbag cushions in the seats positioned in a direction opposite to the collision direction in the event of a broadside collision of the vehicle when the passengers are seated in two opposite seats and the seat positioned in the opposite direction is directed forward or rearward.

The controller may perform control to deploy the left and right airbag cushions in the seat directed toward the inside of the vehicle in the event of a broadside collision of the vehicle when the passengers are seated in two opposite seats and the seat positioned in a direction opposite to the collision direction is directed toward the inside of the vehicle.

The controller may perform control to deploy the left and right airbag cushions in the seat directed toward the outside of the vehicle in the event of a broadside collision of the vehicle when the passengers are seated in two opposite seats and the seat positioned in a direction opposite to the collision direction is directed toward the outside of the vehicle.

A vehicle may include the above-described airbag deployment control system.

The present disclosure provides an airbag deployment control method including: a collision direction determination step of detecting, by a controller, a collision direction in the event of a collision of a vehicle; a seat detection step of detecting, by the controller, whether a passenger is seated in a seat and a seat direction; and a deployment control step of controlling, by the controller, a plurality of airbag cushions, which are provided for the seat and configured to be deployed in shapes that cover a lateral surface and a front surface of the seat at left or right sides of the seat, to selectively deploy at least one of the plurality of airbag cushions depending on a collision direction of the vehicle, whether the passenger is seated in the seat, and the seat direction.

The present disclosure provides a non-transitory computer readable medium containing program instructions executed by a processor, the computer readable medium including: program instructions that detect a collision direction in the event of a collision of a vehicle; program instructions that detect whether a passenger is seated in a seat and a seat direction; and program instructions that control a plurality of airbag cushions, which are provided for the seat and configured to be deployed in shapes that cover a lateral surface and a front surface of the seat at left or right sides of the seat, to selectively deploy at least one of the plurality of airbag cushions depending on a collision direction of the vehicle, whether the passenger is seated in the seat, and the seat direction.

According to the technical solutions of the present disclosure, the left and right airbag cushions in the seat in which the passenger is seated are selectively deployed depending on the collision direction of the vehicle and the seat direction, which makes it possible to cope with various collision modes and safely protect the passenger.

In particular, in case that the passengers are seated at the left and right sides in a broadside collision situation, at least one of or both the airbag cushions are deployed between the left seat and the right sear, thereby preventing a collision between the passengers and more safely protecting the passengers.

Moreover, the airbag of the present disclosure may be substituted for airbags in other portions, such that the number of types of airbags may be reduced, which prevents increases in costs and weight caused by the addition of airbags.

### BRIEF DESCRIPTION OF THE DRAWINGS

FIG. 1 is a view illustrating a state in which an airbag cushion according to the present disclosure is deployed.

FIG. 2 is a view exemplarily illustrating a state in which the airbag cushion is deployed when left and right passengers are seated in a forward-facing mode according to the present disclosure.

FIG. 3 is a configuration view of an airbag deployment control system according to the present disclosure.

FIGS. 4 to 7 are views illustrating an embodiment in which the airbag cushion is deployed in a broadside collision situation at a driver seat side when a driver seat passenger is seated in the forward-facing mode.

FIGS. 8 to 11 are views illustrating an embodiment in which the airbag cushion is deployed in a broadside collision situation at a passenger seat side when a driver seat passenger is seated in the forward-facing mode.

FIGS. 12 to 15 are views illustrating an embodiment in which the airbag cushion is deployed in a broadside collision situation at the driver seat side when the driver seat passenger is seated in a rearward-facing mode.

FIGS. 16 to 19 are views illustrating an embodiment in which the airbag cushion is deployed in a broadside collision situation at the passenger seat side when the driver seat passenger is seated in the rearward-facing mode.

FIGS. 20 to 23 are views illustrating an embodiment in which the airbag cushion is deployed in a broadside collision situation at the driver seat side when the driver seat passenger is seated in a 90-degree turn mode.

FIGS. 24 to 27 are views illustrating an embodiment in which the airbag cushion is deployed in a broadside collision situation at the passenger seat side when the driver seat passenger is seated in the 90-degree turn mode.

FIGS. 28 to 31 are views illustrating an embodiment in which the airbag cushion is deployed in a broadside collision situation at the driver seat side when the driver seat passenger is seated in a 270-degree turn mode.

FIGS. 32 to 35 are views illustrating an embodiment in which the airbag cushion is deployed in a broadside collision situation at the passenger seat side when the driver seat passenger is seated in the 270-degree turn mode.

FIGS. 36 to 39 are views illustrating an embodiment in which the airbag cushion is deployed according to a seat arrangement for a passenger seat passenger in a broadside collision situation at the driver seat side when the driver seat passenger is seated in the forward-facing mode and the passenger seat passenger is seated.

FIGS. 40 to 43 are views illustrating an embodiment in which the airbag cushion is deployed according to the seat arrangement for the passenger seat passenger in a broadside collision situation at the driver seat side when the driver seat passenger is seated in the rearward-facing mode and the passenger seat passenger is seated.

FIGS. 44 to 47 are views illustrating an embodiment in which the airbag cushion is deployed according to the seat arrangement for the passenger seat passenger in a broadside collision situation at the driver seat side when the driver seat passenger is seated in the 90-degree turn mode and the passenger seat passenger is seated.

FIGS. 48 to 51 are views illustrating an embodiment in which the airbag cushion is deployed according to the seat arrangement for the passenger seat passenger in a broadside collision situation at the driver seat side when the driver seat passenger is seated in the 270-degree turn mode and the passenger seat passenger is seated.

FIGS. 52 to 55 are views illustrating an embodiment in which the airbag cushion is deployed according to the seat arrangement for the passenger seat passenger in a broadside collision situation at the passenger seat side when the driver seat passenger is seated in the forward-facing mode and the passenger seat passenger is seated.

FIGS. 56 to 59 are views illustrating an embodiment in which the airbag cushion is deployed according to the seat arrangement for the passenger seat passenger in a broadside collision situation at the passenger seat side when the driver seat passenger is seated in the rearward-facing mode and the passenger seat passenger is seated.

FIGS. 60 to 63 are views illustrating an embodiment in which the airbag cushion is deployed according to the seat arrangement for the passenger seat passenger in a broadside collision situation at the passenger seat side when the driver seat passenger is seated in the 90-degree turn mode and the passenger seat passenger is seated.

FIGS. 64 to 67 are views illustrating an embodiment in which the airbag cushion is deployed according to the seat arrangement for the passenger seat passenger in a broadside collision situation at the passenger seat side when the driver seat passenger is seated in the 270-degree turn mode and the passenger seat passenger is seated.

FIG. 68 is a block diagram illustrating an airbag deployment control method for respective steps according to the present disclosure.

FIGS. 69 and 70 are flow charts exemplarily illustrating airbag deployment control processes according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, “portion” and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments disclosed in the present specification will be described in detail with reference to the accompanying drawings. The same or similar constituent elements are assigned with the same reference numerals regardless of reference numerals, and the repetitive description thereof will be omitted.

In the description of the embodiments disclosed in the present specification, the specific descriptions of publicly known related technologies will be omitted when it is determined that the specific descriptions may obscure the subject matter of the embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

A controller may include a communication device configured to communicate with another controller or a sensor to control a corresponding function, a memory configured to store an operating system, a logic instruction, and input/output information, and one or more processors configured to perform determination, computation, decision, or the like required to control the corresponding function.

Hereinafter, exemplary embodiments of the present disclosure will be described in detail with reference to the accompanying drawings.

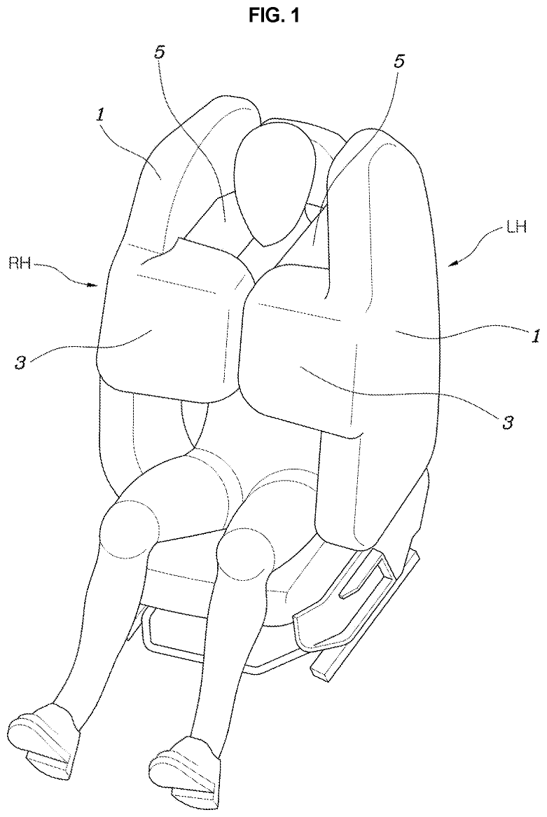

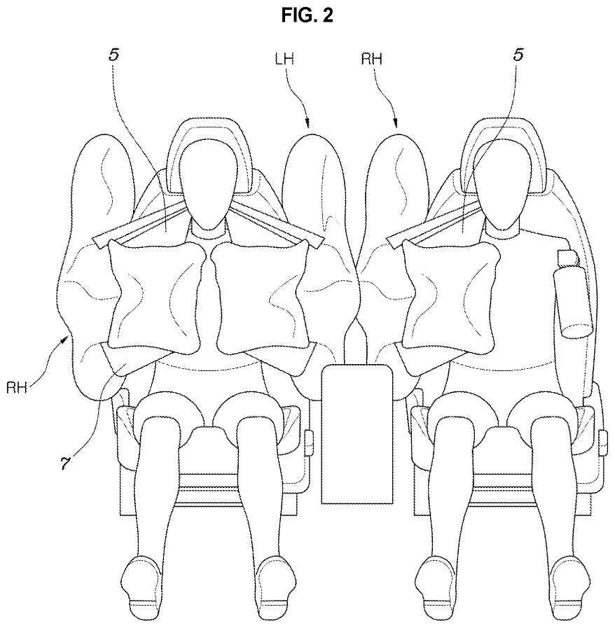

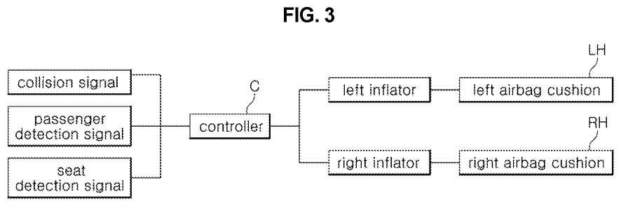

With reference to FIGS. 1 to 3, an airbag deployment control system of the present disclosure includes airbag cushions LH and RH provided for respective seats and configured to be deployed in shapes that cover a lateral surface and a front surface of the seat at left and right sides of the seat, and a controller C configured to perform control to selectively deploy the left and right airbag cushions LH and RH for each of the seats depending on a collision direction of a vehicle, whether a passenger is seated in the seat, and a seat direction.

The airbag cushions LH and RH applied to the present disclosure will be described with reference to the drawings. The airbag cushions LH and RH each include a lateral chamber 1 configured to be deployed in a shape that covers the lateral surface of the seat, and a front chamber 3 configured to be deployed in a shape that covers the front surface of the seat.

The lateral chamber 1 is deployed to be elongated in an upward/downward longitudinal direction while being deployed forward from a left or right side of a seatback.

The lateral chamber 1 is deployed to a space between a passenger and a vehicle structure such as a door and a center console and protects the passenger's head, shoulder, chest, abdomen, and pelvis that are main parts of the lateral side of the passenger.

The front chambers 3 are respectively connected to front ends of the lateral chambers 1 disposed at the left and right sides and configured to be deployed in shapes shape bent toward the front side of the passenger.

The front chamber 3 is deployed to protect a region from the passenger's shoulder to the passenger's abdomen.

Further, an upper end tether 5 having a planar shape is connected to an upper end of the front chamber 3, an inner surface of the lateral chamber 1 connected to an upper end of the front chamber 3, and a seat back frame at an upper end of the seatback.

Therefore, when the airbag cushions LH and RH are deployed, the upper end tethers 5 are deployed while passing over the shoulders of the passenger and serve to support a load of the passenger while restricting deployment shapes of the upper ends of the airbag cushions LH and RH.

Further, a lower end tether 7 having a planar shape is connected to a lower end of the front chamber 3, the inner surface of the lateral chamber 1 connected to the lower end of the front chamber 3, and the seat back frame of a lower end of the seatback.

Therefore, when the airbag cushions LH and RH are deployed, the lower end tethers 7 are deployed while passing over the thighs of the passenger and serve to support a load of the passenger while restricting deployment shapes of the lower ends of the airbag cushions LH and RH.

Further, a plurality of collision sensors may be mounted in the vehicle to detect a collision direction in the event of a collision accident of the vehicle.

Further, a sensor for detecting whether the passenger is seated in the seat may be installed in the vehicle, and a sensor for detecting a seat direction may be installed in the vehicle. These sensors may include an image sensor configured to capture an image of an interior of an occupant compartment, a load sensor installed in the seat, and the like.

That is, when a collision accident of the vehicle occurs, signals detected by the sensors are inputted to the controller C. On the basis of the inputted signals, the controller C determines the collision direction of the vehicle, whether the passenger is seated in the seat, and the direction of the seat in which the passenger is seated.

Therefore, on the basis of the collision direction of the vehicle and the seat direction, the left and right airbag cushions LH and RH in the seat in which the passenger is seated are selectively deployed.

Therefore, the passenger is optimally restrained in various seat positions, which may cope with various collision modes and safely protect the passenger.

Moreover, the airbag may be substituted for airbags in other portions, such that the number of types of airbags may be reduced, which prevents increases in costs and weight caused by the addition of airbags.

Meanwhile, in the present disclosure, both the left and right airbags may be controlled to be deployed in a head-on collision and an oblique collision situation.

Specifically, the controller C may perform control to deploy the left and right airbag cushions LH and RH in the seat in which the passenger is seated regardless of the seat direction in the event of a head-on collision of the vehicle.

That is, the seats of the vehicle may be arranged in various shapes such as a forward-facing mode, a rearward-facing mode, and a ½-row face-to-face seating mode.

However, in a head-on collision situation of the vehicle, the airbag cushions LH and RH are simultaneously deployed at the left and right sides of all the seats in which the passengers are seated regardless of the directions (arrangements) of the seats, such that the airbag cushions LH and RH cover the two opposite surfaces and the front surface of each of the passengers, thereby safely protecting the passengers.

Further, the controller C may perform control to deploy the left and right airbag cushions LH and RH in the seat in which the passenger is seated regardless of the seat direction in the event of a frontal broadside oblique collision of the vehicle.

That is, as in the head-on collision situation, in a frontal oblique collision situation of the vehicle, the airbag cushions LH and RH are simultaneously deployed at the left and right sides of all the seats in which the passengers are seated regardless of the directions (arrangements) of the seats, such that the airbag cushions LH and RH cover the two opposite surfaces and the front surface of each of the passengers, thereby safely protecting the passengers.

Meanwhile, in a broadside collision situation, the airbag of the present disclosure may be controlled so that both the left and right airbag cushions LH and RH are deployed or only one of the left and right airbag cushions LH and RH is deployed depending on whether one or two passengers are seated and the direction of the seat in which the passenger is seated.

First, a case in which one passenger is seated will be described. In case that the passenger is seated only in one side seat in the event of a broadside collision of the vehicle, the controller C may perform control to deploy only the airbag cushions LH and RH in the seat in which the passenger is seated and to selectively deploy the left and right airbag cushions LH and RH depending on the collision direction and the direction of the seat in which the passenger is seated.

Specifically, in case that the passenger is seated only in one side seat and the direction of the seat, in which the passenger is seated, is directed forward or rearward in the event of a broadside collision of the vehicle, the controller C may perform control to deploy only the airbag cushions LH and RH disposed in the direction in which the collision occurs, among the left and right airbag cushions LH and RH in the seat in which the passenger is seated.

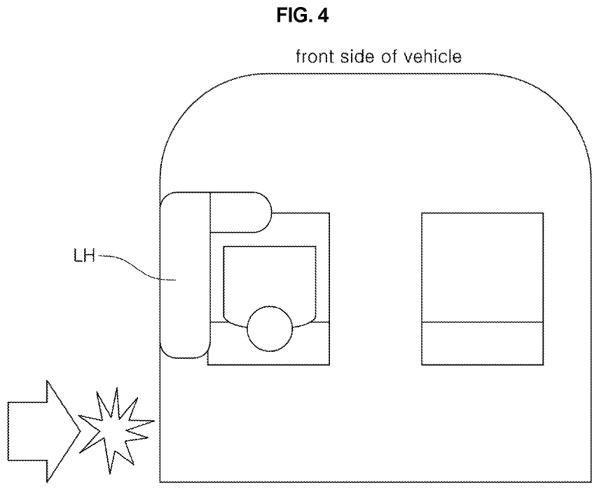

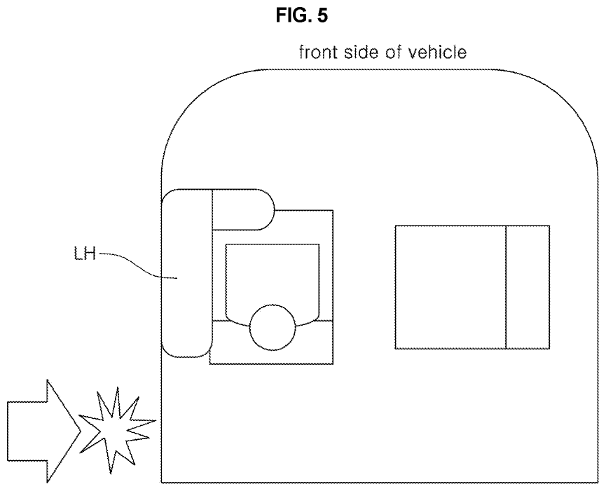

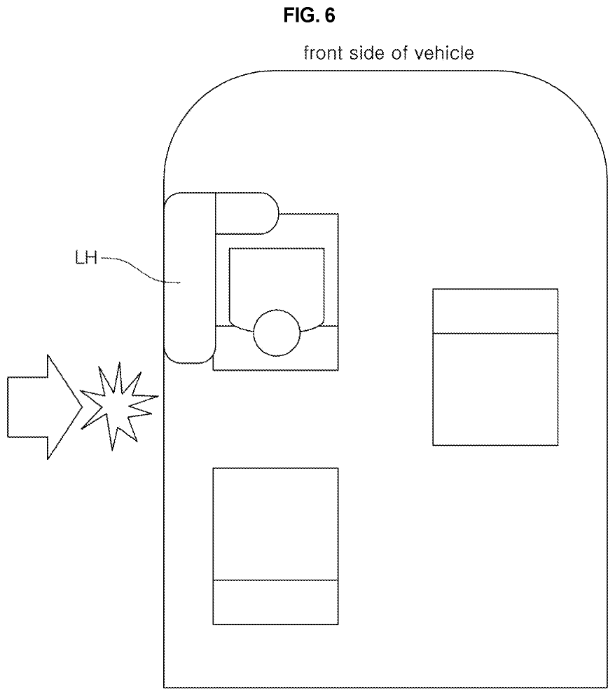

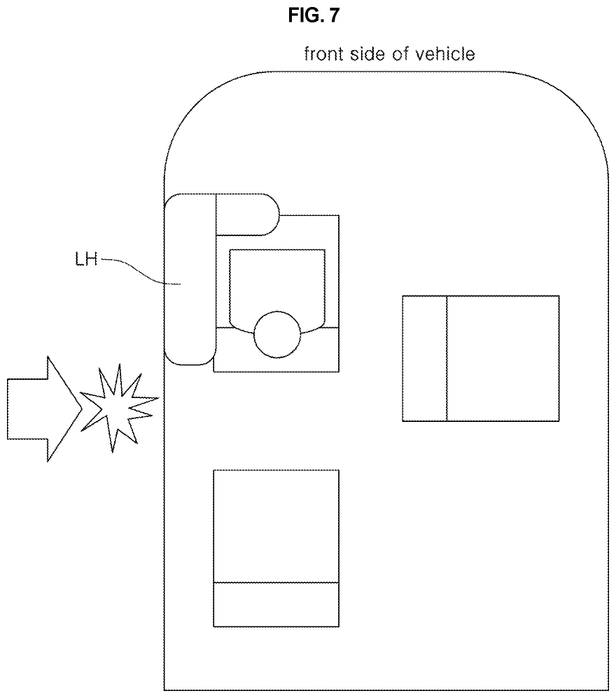

For example, as illustrated in FIGS. 4 to 7, when a broadside collision accident occurs in a driver seat direction in a state in which one passenger is seated in a left driver seat in the forward-facing mode, the right airbag cushion RH in the driver seat is not deployed, but only the left airbag cushion LH is deployed.

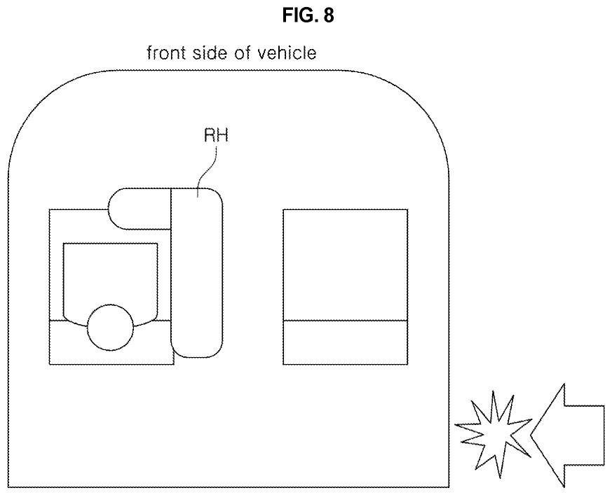

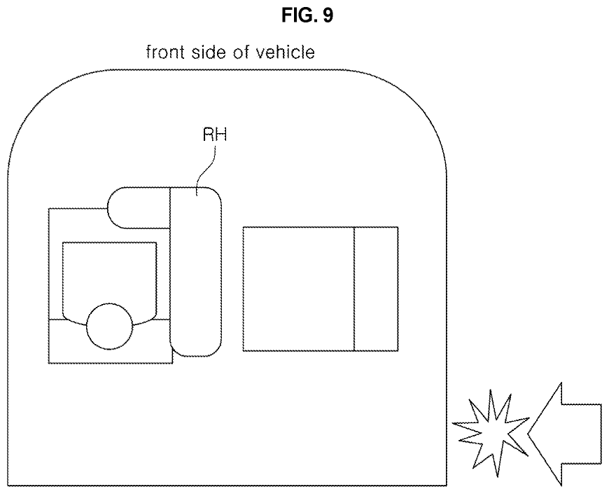

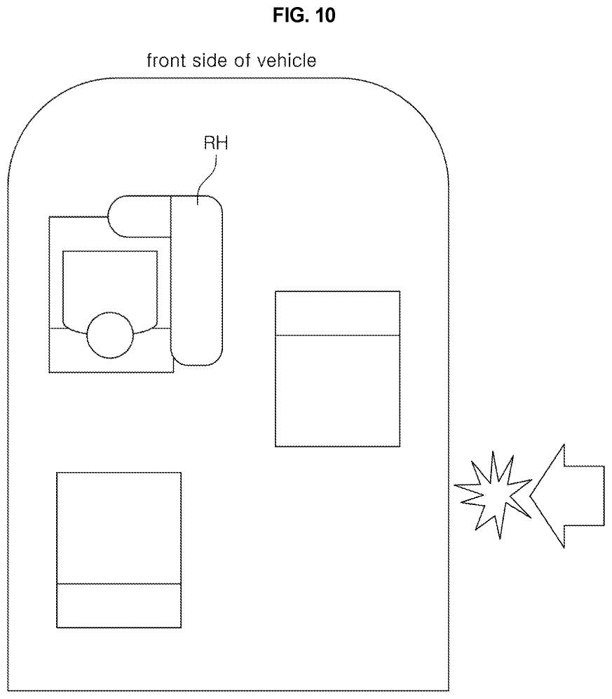

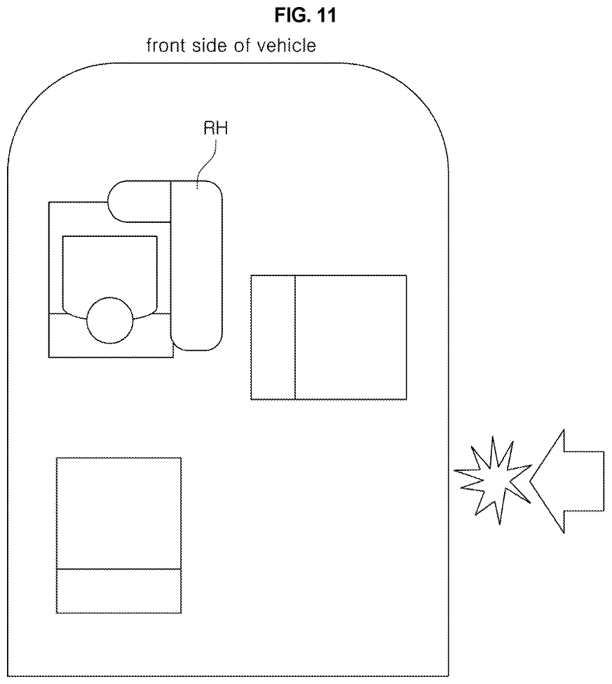

As another example, as illustrated in FIGS. 8 to 11, when a broadside collision accident occurs in a passenger seat direction in a state in which one passenger is seated in the left driver seat in the forward-facing mode, the left airbag cushion LH in the driver seat is not deployed, but only the right airbag cushion RH is deployed.

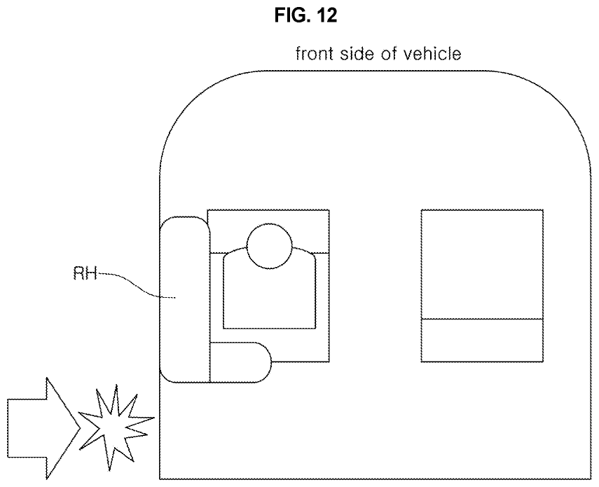

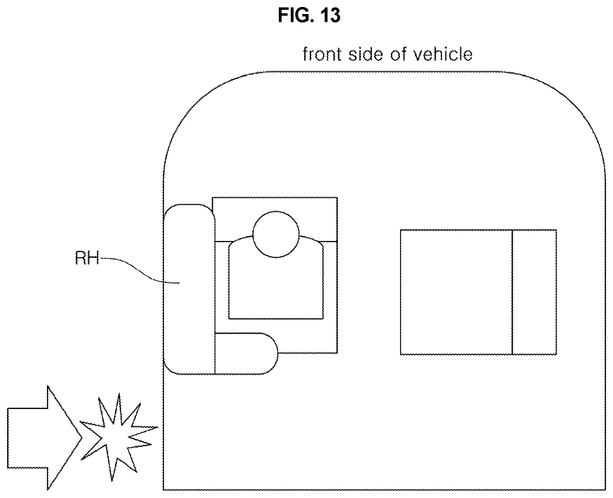

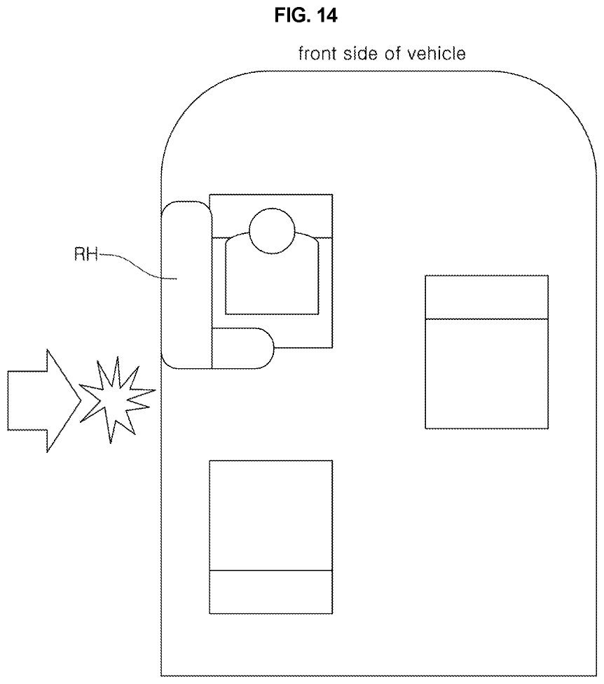

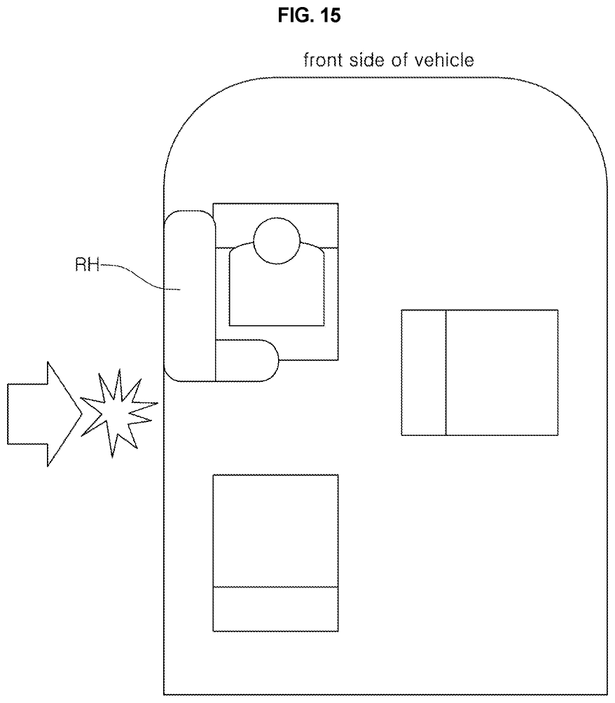

As still another example, as illustrated in FIGS. 12 to 15, when a broadside collision accident occurs in the driver seat direction in a state in which one passenger is seated in the left driver seat in the rearward-facing mode, the left airbag cushion LH in the driver seat is not deployed, but only the right airbag cushion RH is deployed.

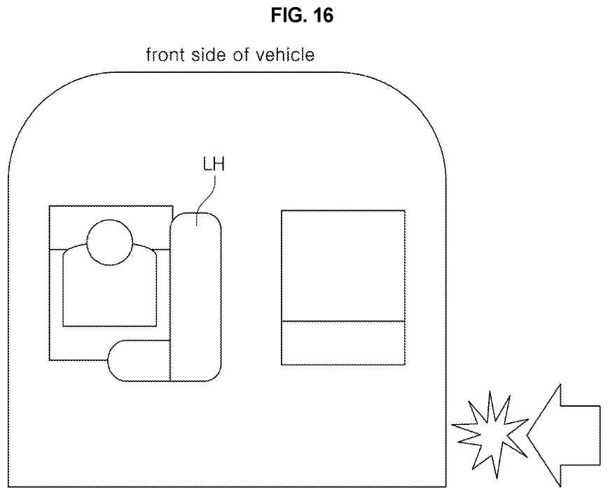

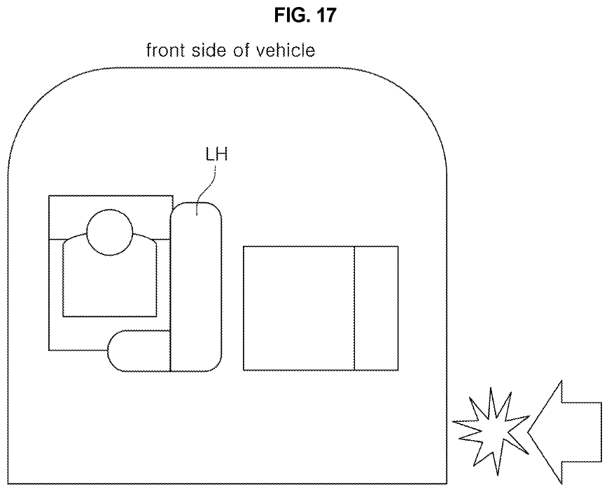

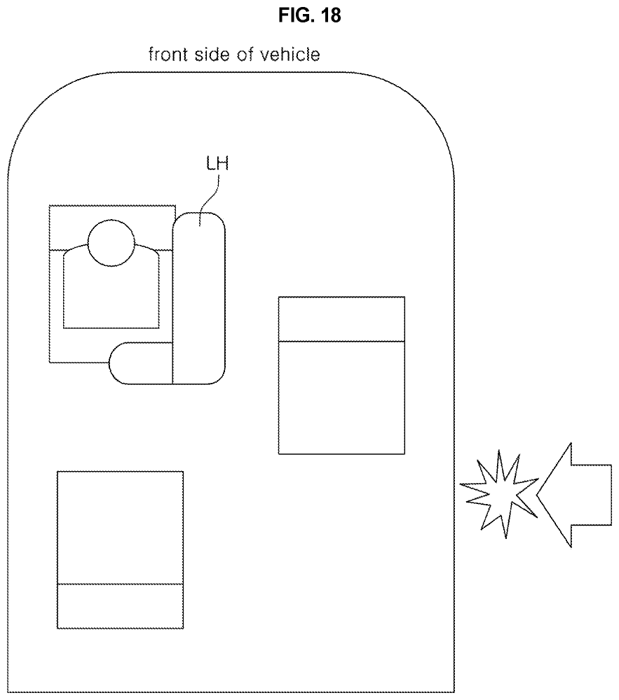

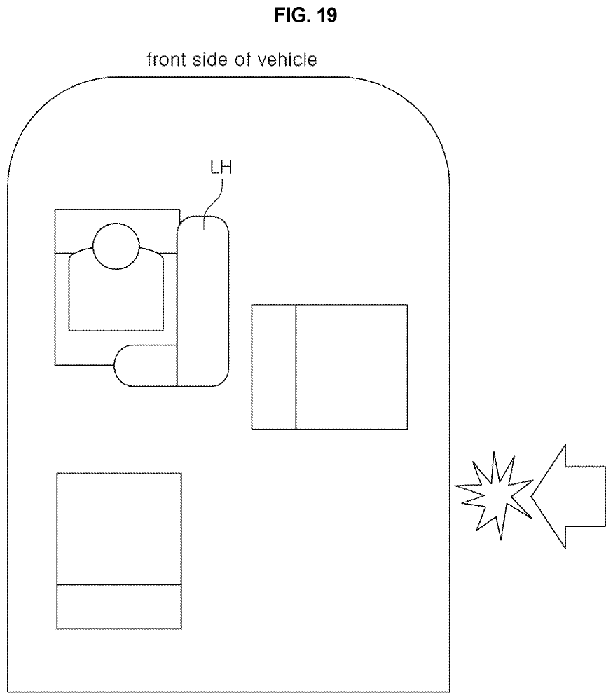

As yet another example, as illustrated in FIGS. 16 to 19, when a broadside collision accident occurs in the passenger seat direction in a state in which one passenger is seated in the left driver seat in the rearward-facing mode, the right airbag cushion RH in the driver seat is not deployed, but only the left airbag cushion LH is deployed.

In this case, because no passenger is seated in the remaining seats except for the left driver seat, the airbag cushions LH and RH in the seat in which no passenger is seated is controlled so as not to be deployed regardless of the seat direction.

Next, the controller C may perform control to deploy the right airbag cushion RH in the event of the broadside collision of the vehicle in case that the passenger is seated only in one side seat, the direction of the seat in which the passenger is seated is directed toward the inside of the vehicle, and the collision occurs in one direction.

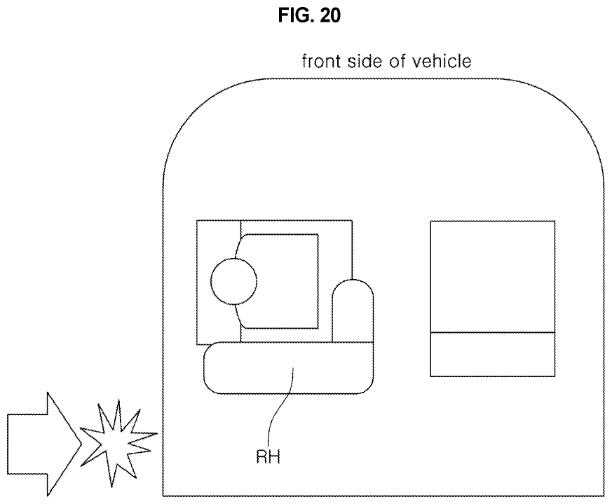

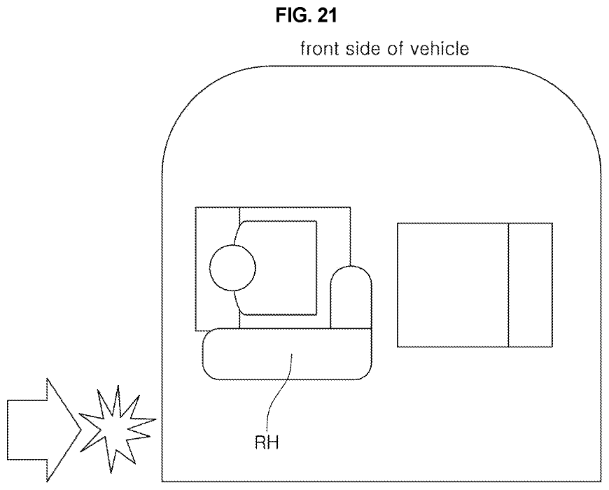

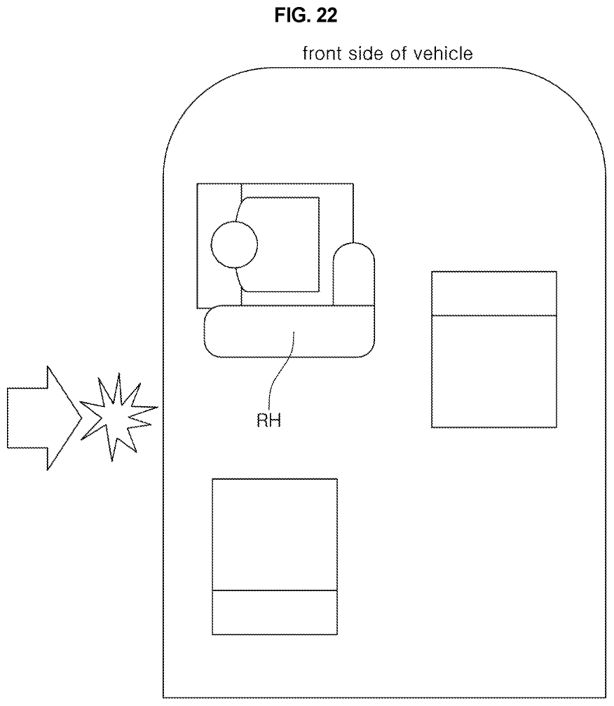

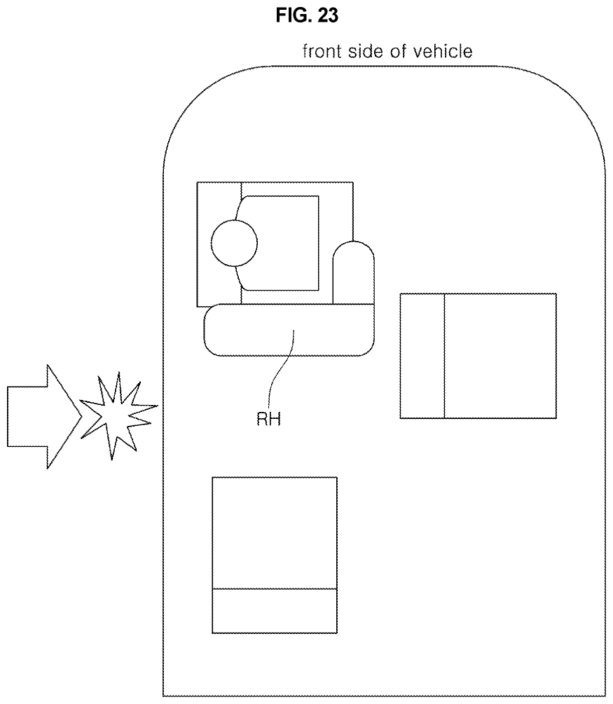

For example, as illustrated in FIGS. 20 to 23, when a broadside collision accident occurs in the driver seat direction in a state in which the left driver seat is turned at 90° toward a passenger seat and one passenger is seated in the driver seat, the left airbag cushion LH in the driver seat is not deployed, but only the right airbag cushion RH is deployed.

Further, the controller C may perform control to deploy the left airbag cushion LH in the event of a broadside collision of the vehicle in case that the passenger is seated only in one side seat, the direction of the seat in which the passenger is seated is directed toward the inside of the vehicle, and the collision occurs in the other direction.

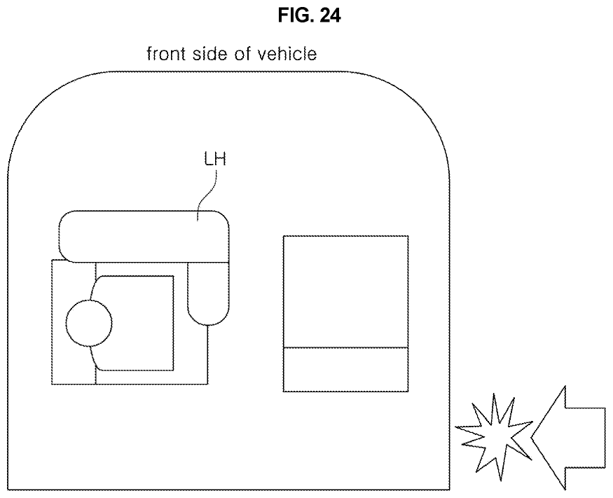

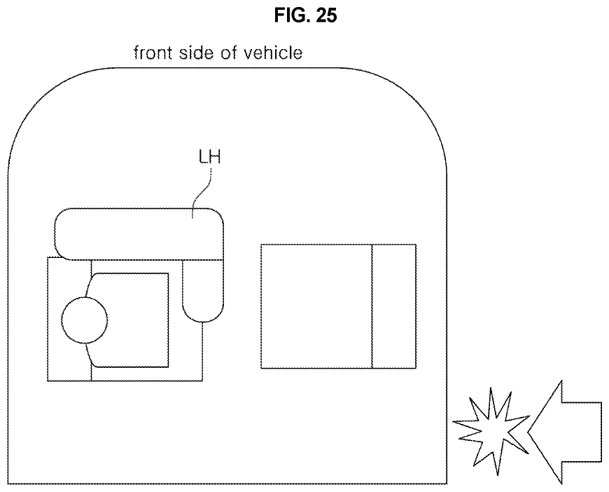

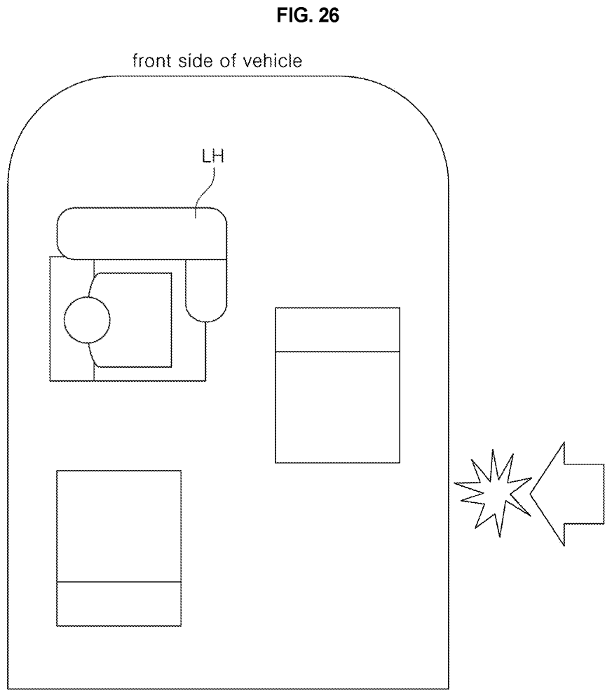

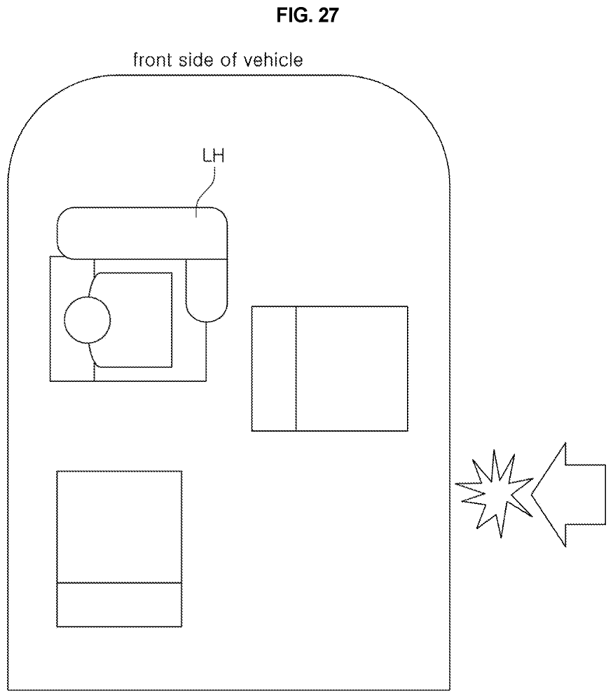

For example, as illustrated in FIGS. 24 to 27, when a broadside collision accident occurs in the passenger seat direction in a state in which the left driver seat is turned at 90° toward the passenger seat and one passenger is seated in the driver seat, the right airbag cushion RH in the driver seat is not deployed, but only the left airbag cushion LH is deployed.

In this case, because no passenger is seated in the remaining seats except for the left driver seat, the airbag cushions LH and RH in the seat in which no passenger is seated is controlled so as not to be deployed regardless of the seat direction.

Continuously, the controller C may perform control to deploy the left and right airbag cushions LH and RH in the seat in the event of a broadside collision of the vehicle in which the passenger is seated in case that the passenger is seated only in one side seat and the direction of the seat in which the passenger is seated is directed toward the outside of the vehicle.

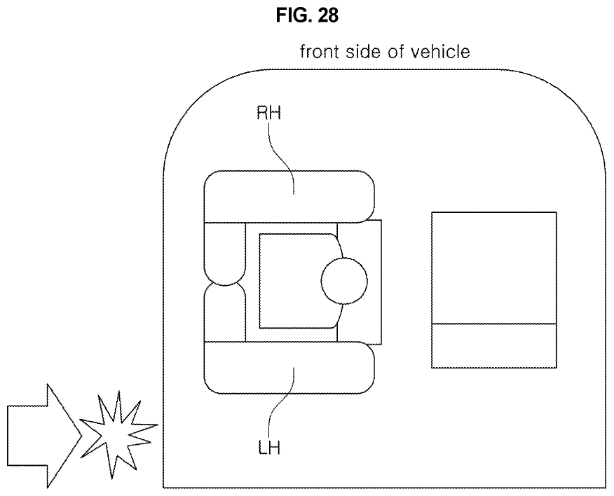

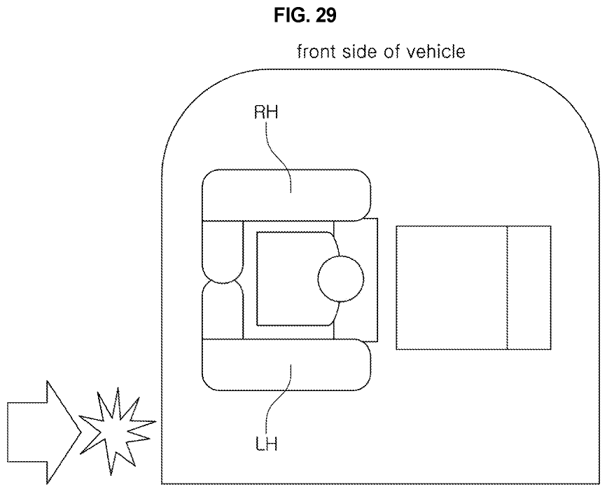

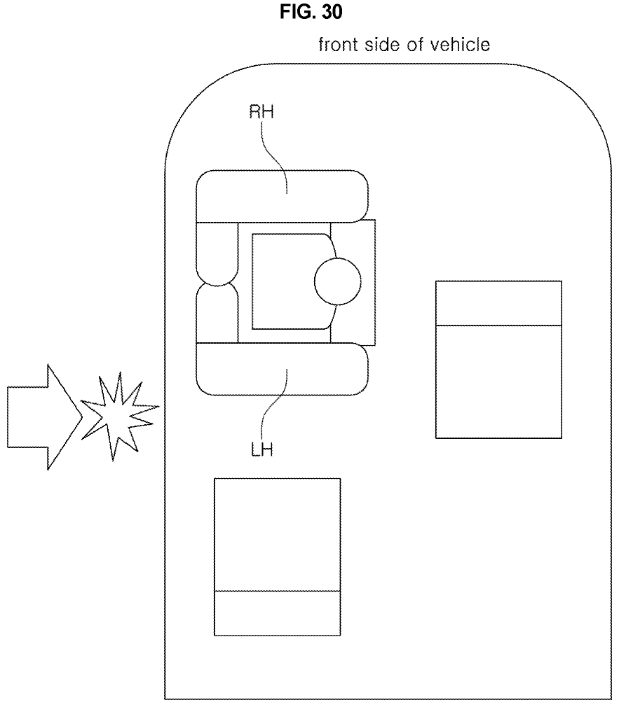

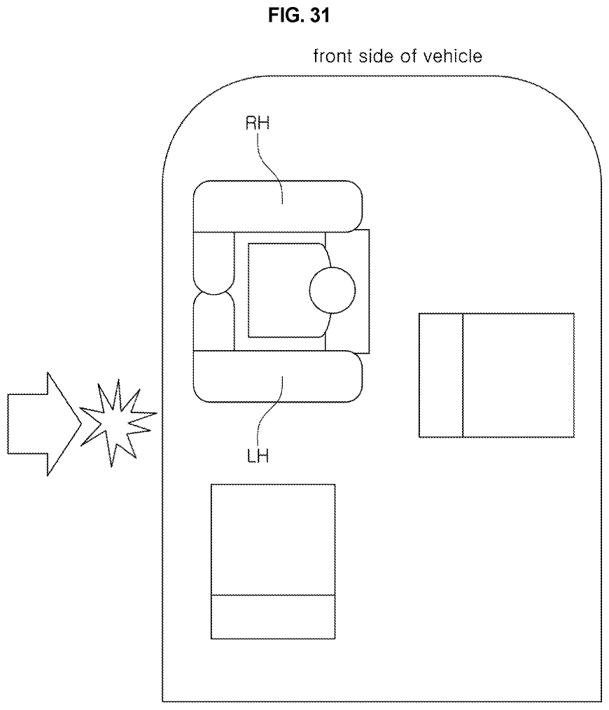

For example, as illustrated in FIGS. 28 to 31, when a broadside collision accident occurs in the driver seat direction in a state in which the left driver seat is turned at 270° in a direction facing away from the passenger seat and one passenger is seated in the driver seat, both the left and right airbag cushions LH and RH in the driver seat are simultaneously deployed.

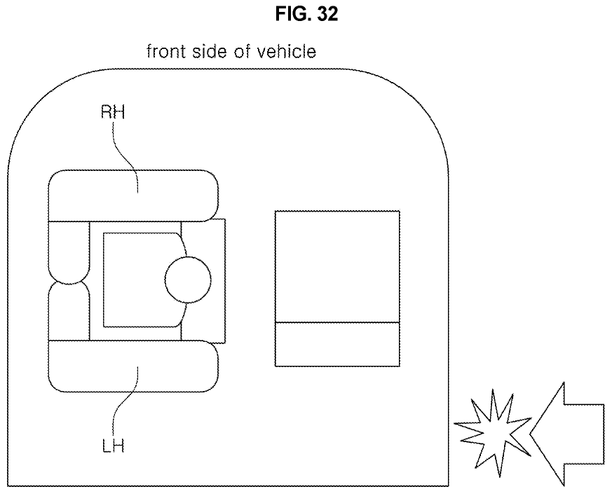

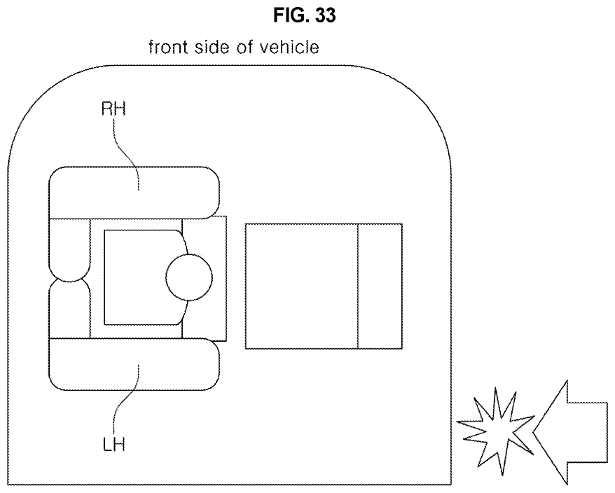

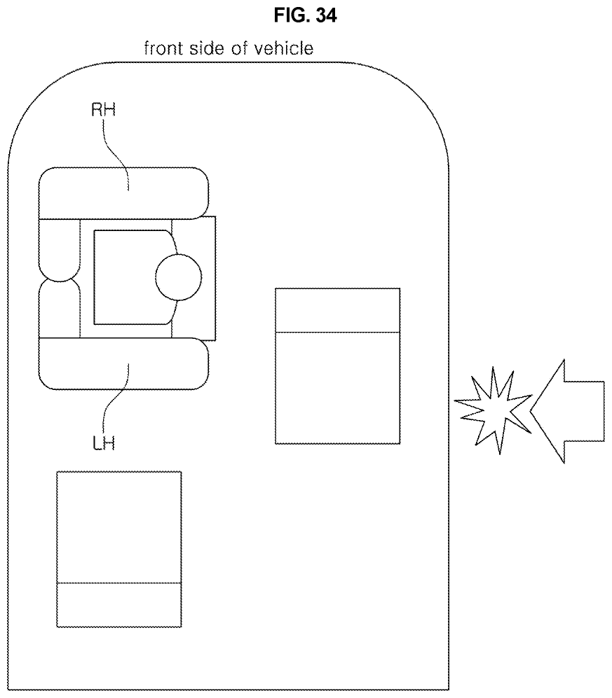

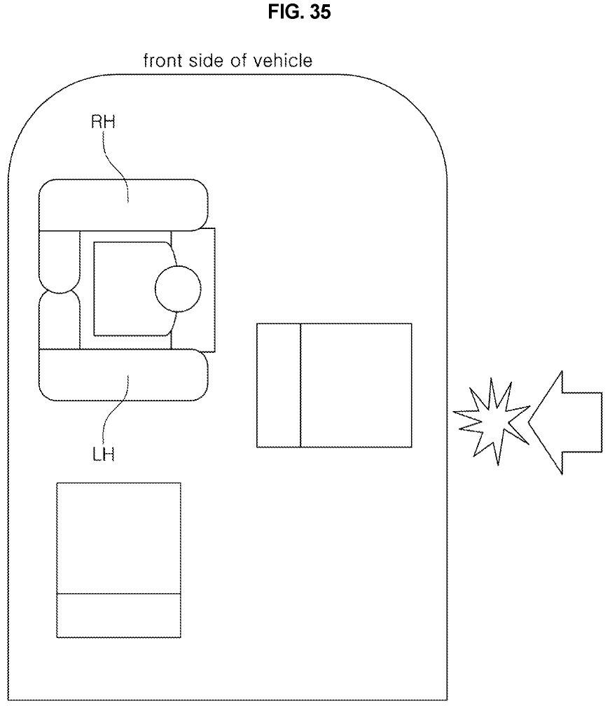

As another example, as illustrated in FIGS. 32 to 35, when a broadside collision accident occurs in the passenger seat direction in a state in which the left driver seat is turned at 270° in the direction facing away from the passenger seat and one passenger is seated in the driver seat, both the left and right airbag cushions LH and RH in the driver seat are simultaneously deployed.

In this case, because no passenger is seated in the remaining seats except for the left driver seat, the airbag cushions LH and RH in the seat in which no passenger is seated is controlled so as not to be deployed regardless of the seat direction.

Meanwhile, a case in which two passengers is seated will be described. In case that the passengers are seated in two opposite seats in the event of a broadside collision of the vehicle, the controller C may perform control to deploy the left and right airbag cushions LH and RH in the seat positioned in the collision direction regardless of the seat direction.

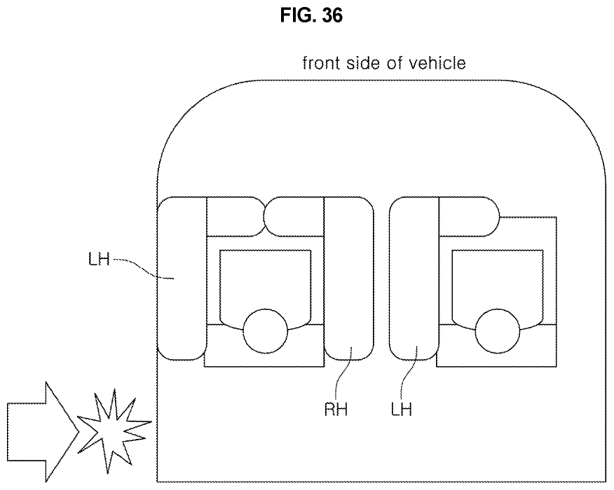

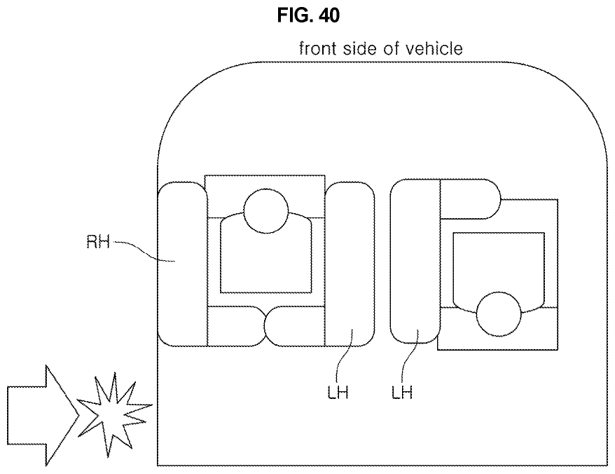

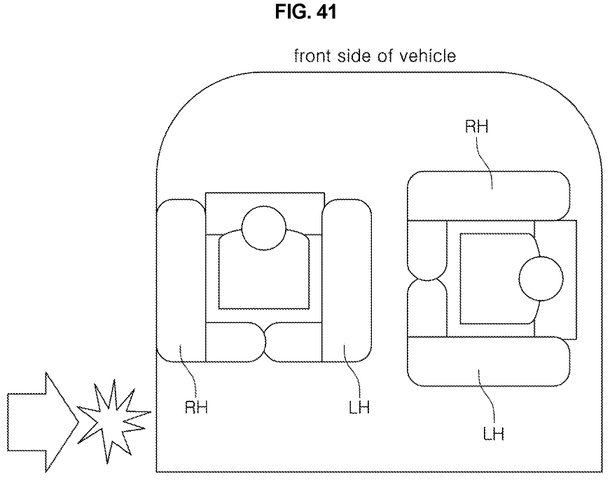

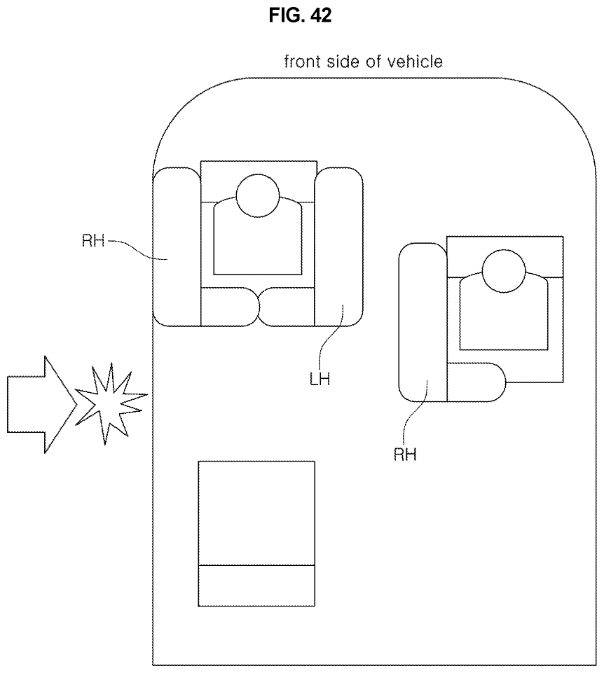

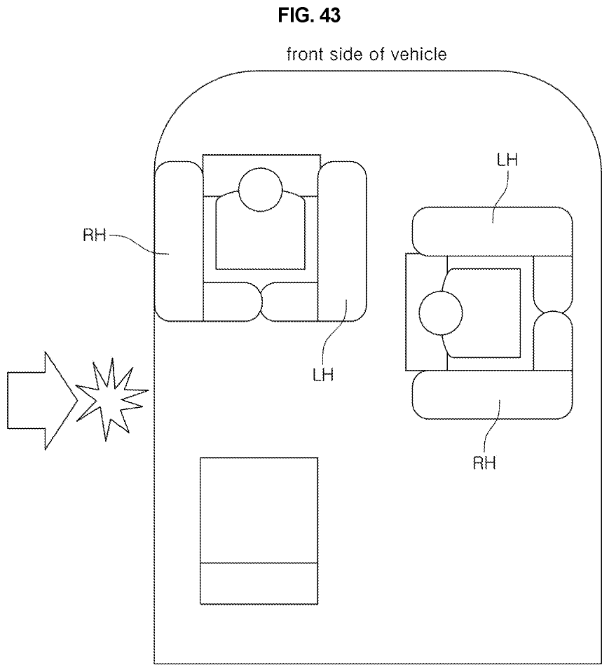

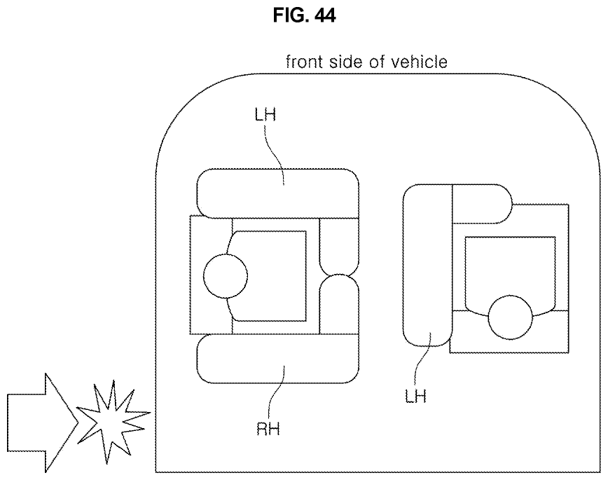

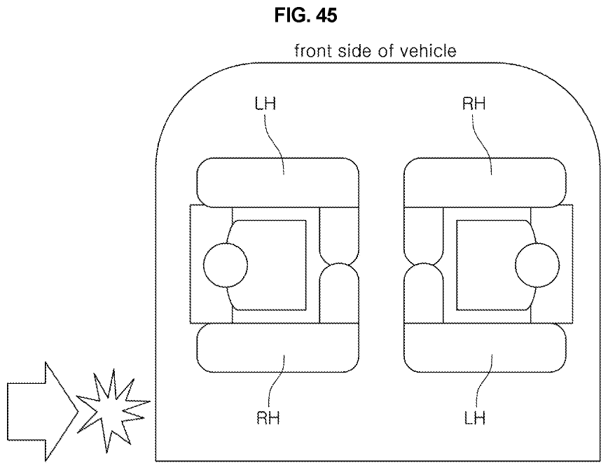

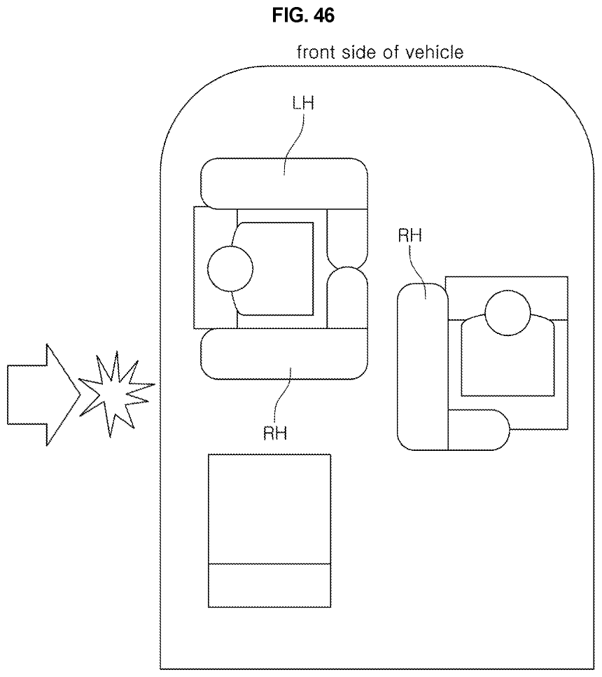

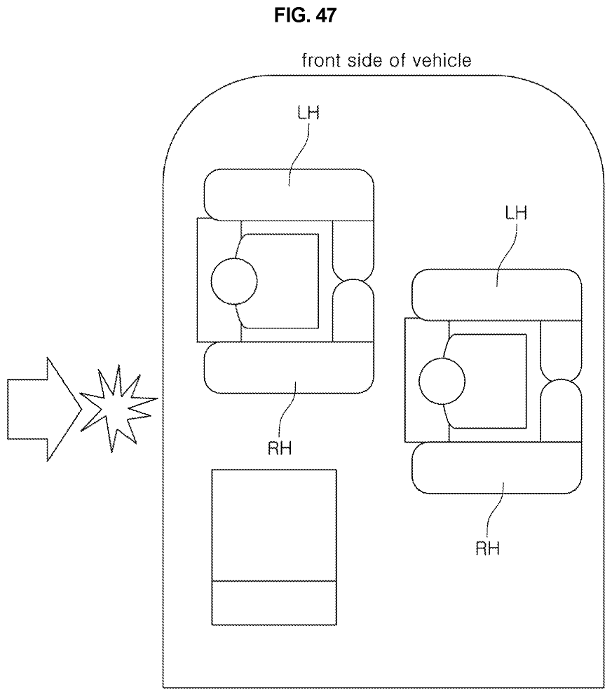

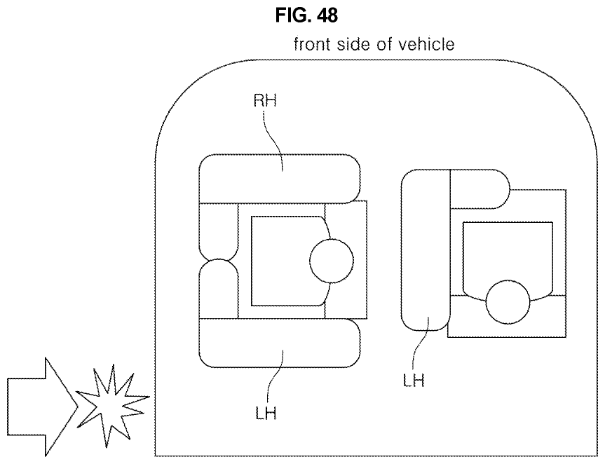

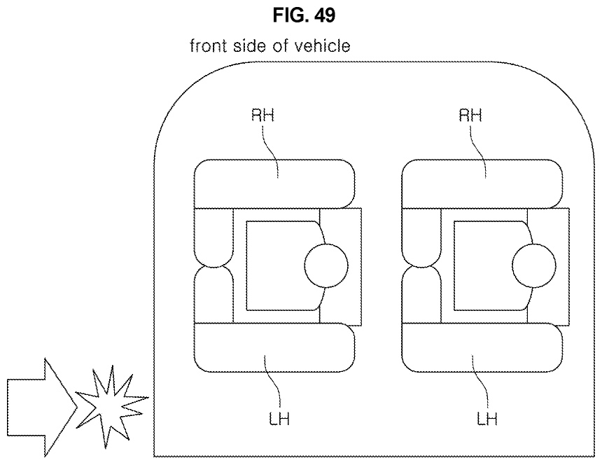

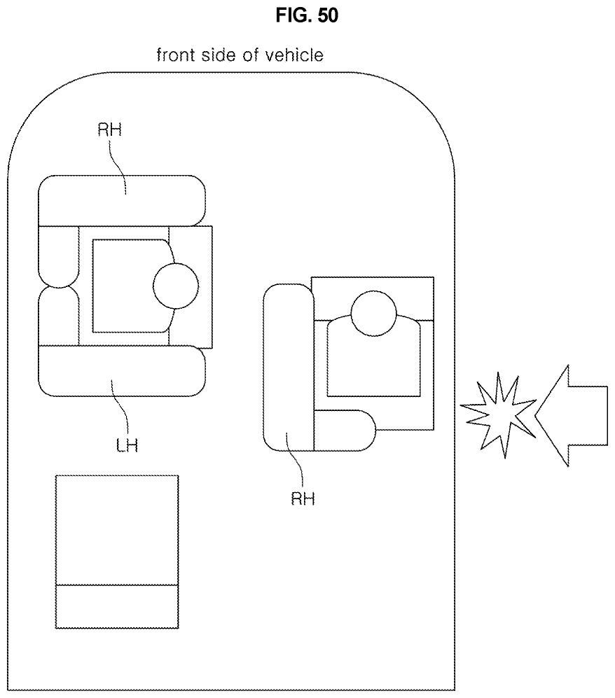

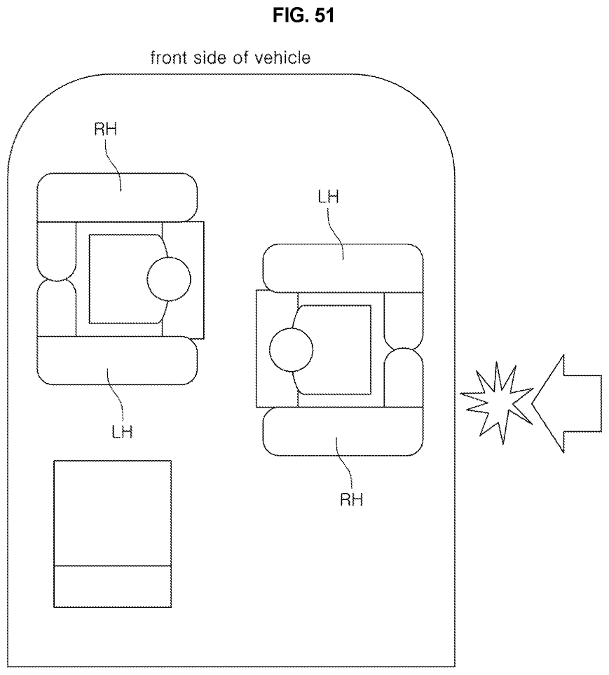

For example, as illustrated in FIGS. 36 to 51, when a broadside collision accident occurs in the driver seat direction in a state in which the passengers are respectively seated in the left driver seat and the right passenger seat, both the left and right airbag cushions LH and RH in the driver seat are simultaneously deployed regardless of the seat arrangement of the driver seat.

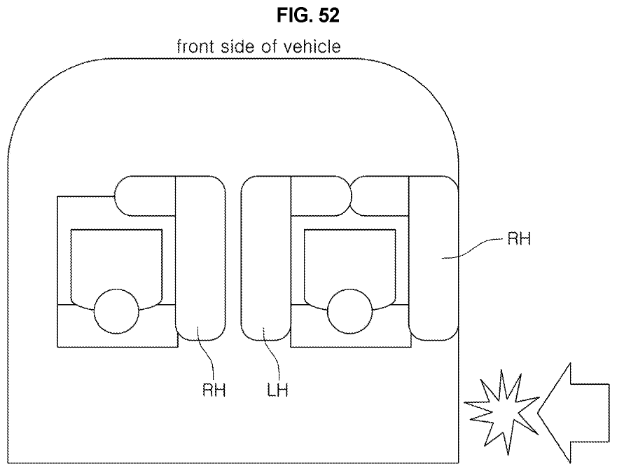

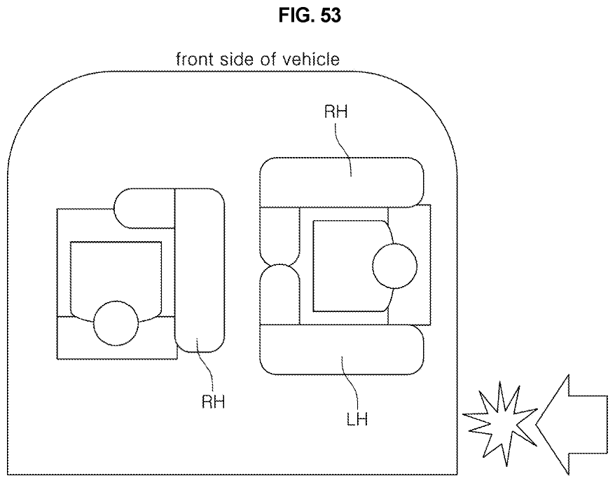

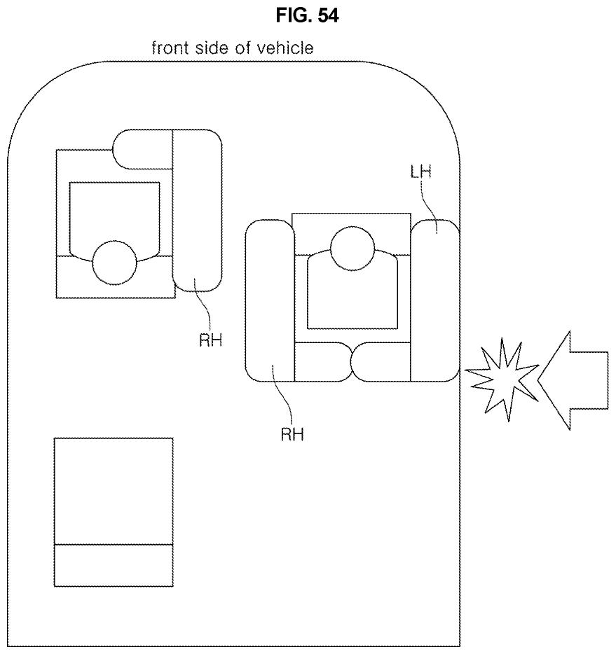

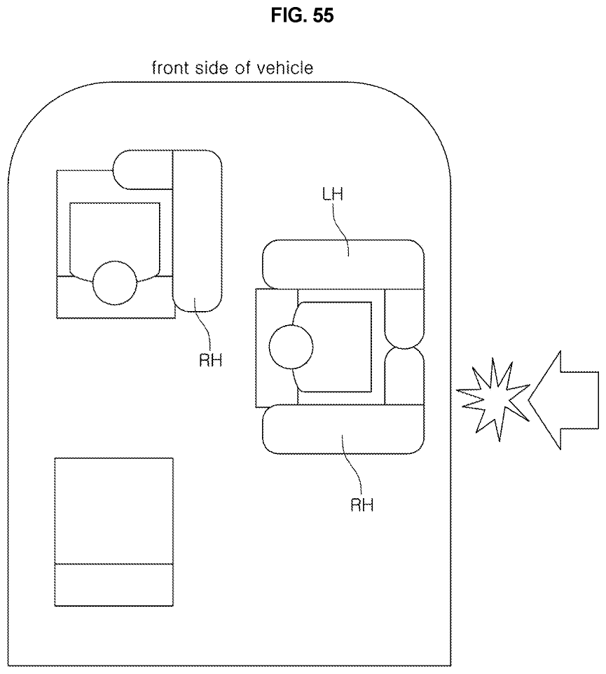

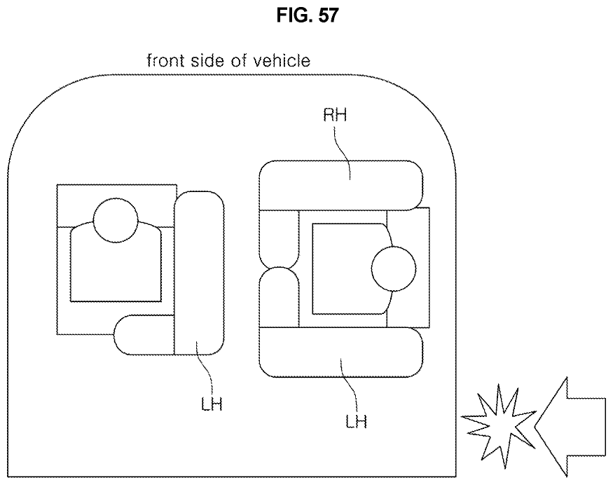

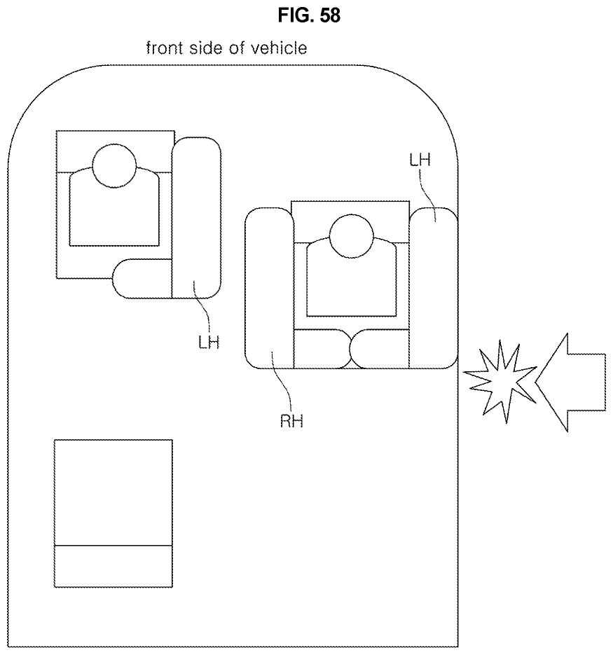

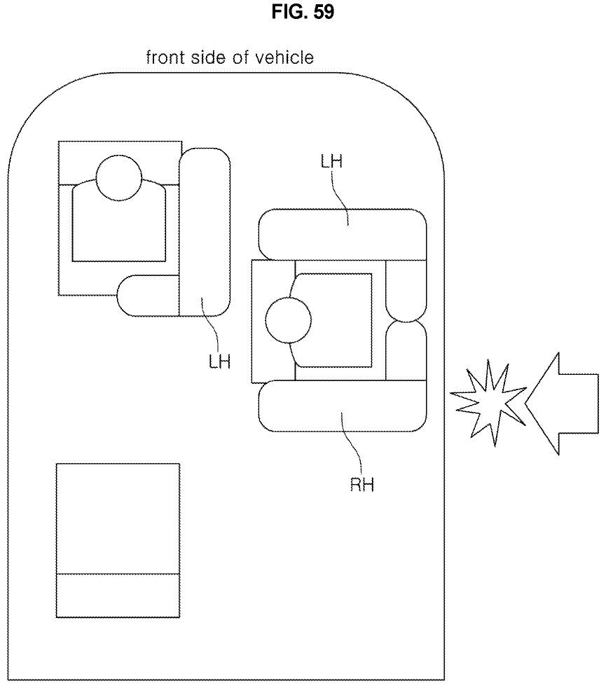

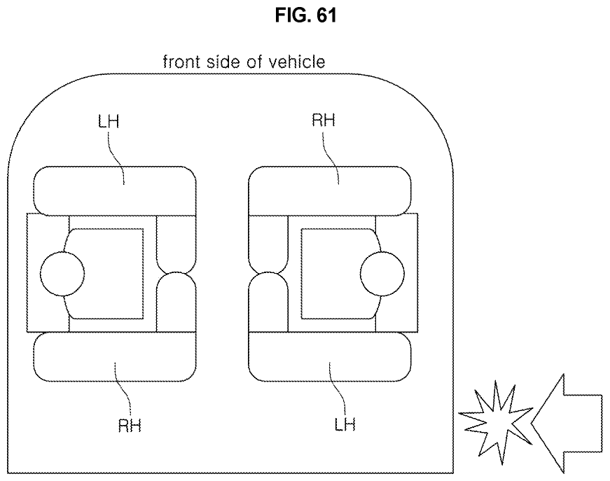

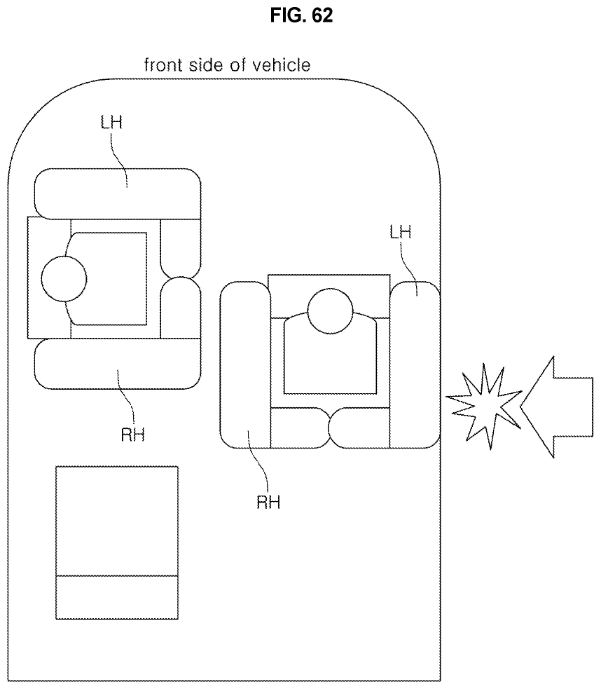

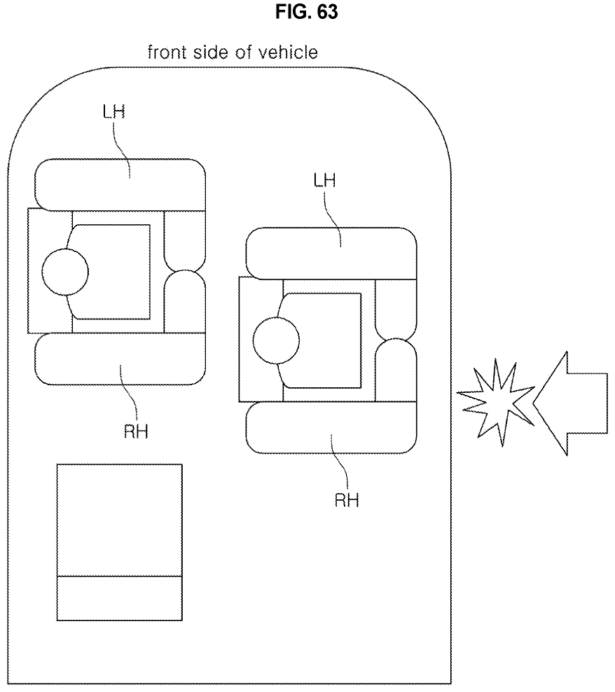

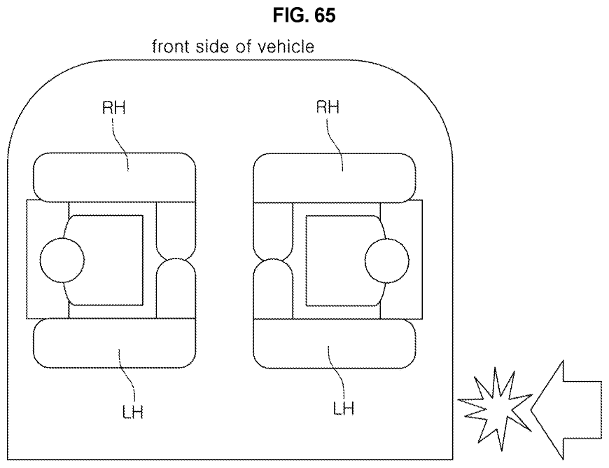

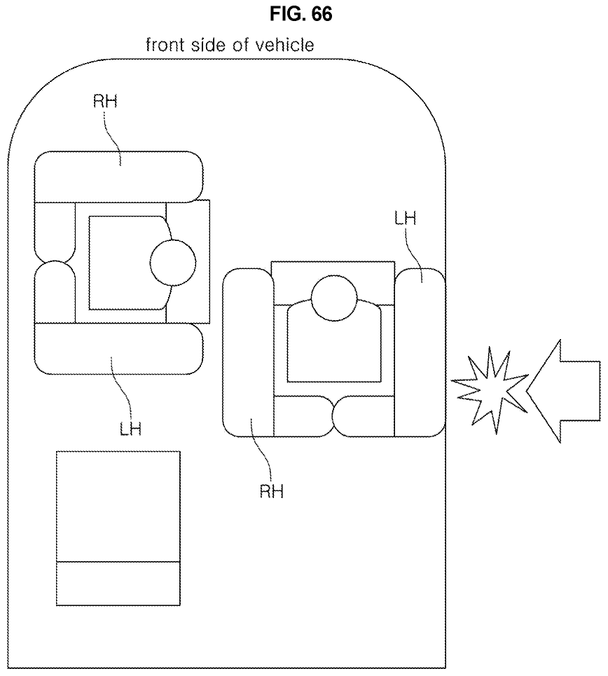

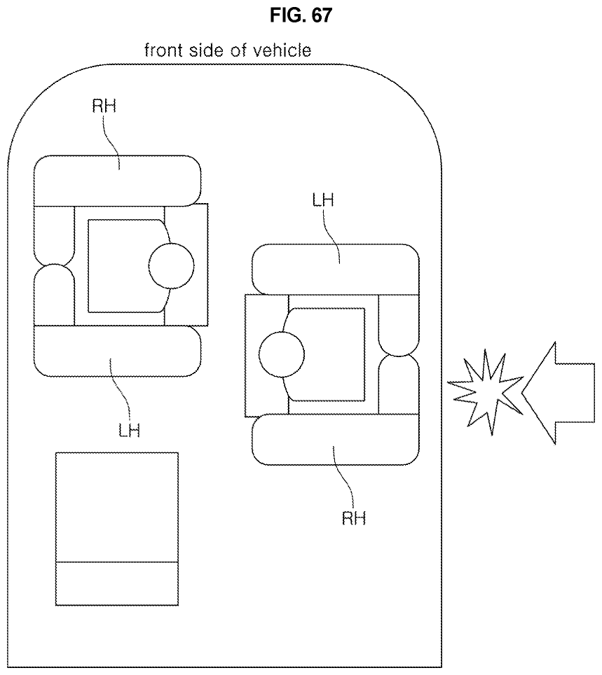

As another example, as illustrated in FIGS. 52 to 67, when a broadside collision accident occurs in the passenger seat direction in a state in which the passengers are respectively seated in the left driver seat and the right passenger seat, both the left and right airbag cushions LH and RH in the passenger seat are simultaneously deployed regardless of the seat arrangement of the passenger seat.

Further, the controller C may perform control to deploy only the airbag cushions LH and RH in the collision direction among the left and right airbag cushions LH and RH in the seats positioned in the opposite direction in the event of a broadside collision of the vehicle in case that the passengers are seated in the two opposite seats and the seat positioned in a direction opposite to the collision direction is directed forward or rearward.

For example, as illustrated in FIGS. 36, 40, 44, and 48, in case that a broadside collision accident occurs in the driver seat direction in a state in which the passengers are respectively seated in the left driver seat and the right passenger seat and the passenger seat passenger is seated in the forward-facing mode, the right airbag cushion RH in the passenger seat is not deployed, but only the left airbag cushion LH is deployed.

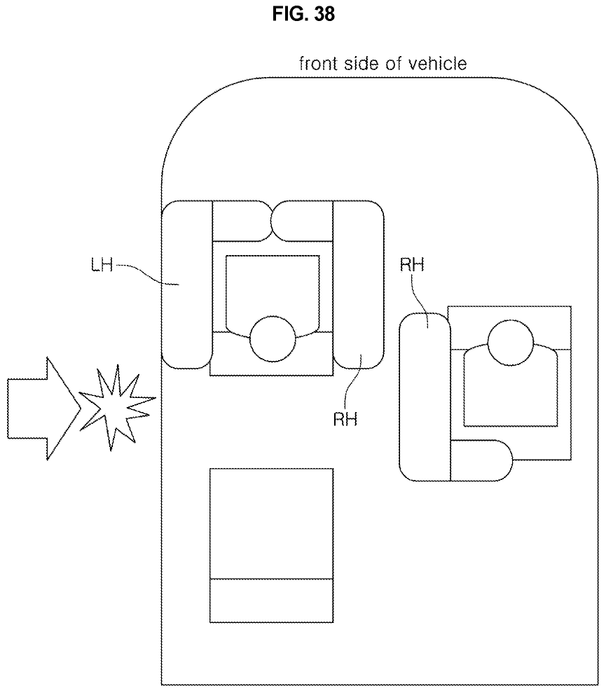

As another example, as illustrated in FIGS. 38, 42, 46, and 50, in case that a broadside collision accident occurs in the driver seat direction in a state in which the passengers are respectively seated in the left driver seat and the right passenger seat and the passenger seat passenger is seated in the rearward-facing mode, the left airbag cushion LH in the passenger seat is not deployed, but only the right airbag cushion RH is deployed.

As still another example, as illustrated in FIGS. 52 to 55, in case that a broadside collision accident occurs in the passenger seat direction in a state in which the passengers are respectively seated in the left driver seat and the right passenger seat and the driver seat passenger is seated in the forward-facing mode, the left airbag cushion LH in the driver seat is not deployed, but only the right airbag cushion RH is deployed.

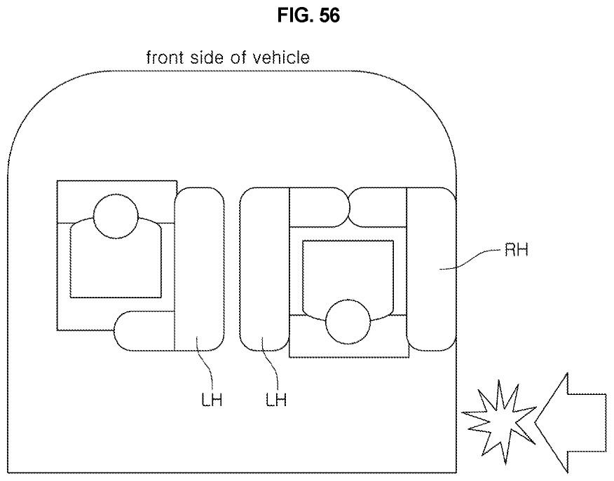

As yet another example, as illustrated in FIGS. 56 to 59, in case that a broadside collision accident occurs in the passenger seat direction in a state in which the passengers are respectively seated in the left driver seat and the right passenger seat and the driver seat passenger is seated in the rearward-facing mode, the right airbag cushion RH in the driver seat is not deployed, but only the left airbag cushion LH is deployed.

Continuously, the controller C may perform control to deploy the left and right airbag cushions LH and RH in the seat directed toward the inside of the vehicle in the event of a broadside collision of the vehicle in case that the passengers are seated in the two opposite seats and the seat positioned in the direction opposite to the collision direction is directed toward the inside of the vehicle.

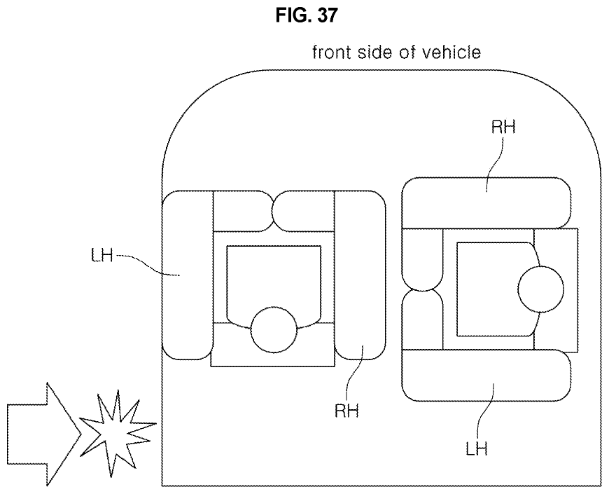

For example, as illustrated in FIGS. 37, 41, 45, and 49, when a broadside collision accident occurs in the driver seat direction in a state in which the right passenger seat is turned at 90° toward the driver seat and the passengers are respectively seated in the left driver seat and the right passenger seat, both the left and right airbag cushions LH and RH in the passenger seat are simultaneously deployed.

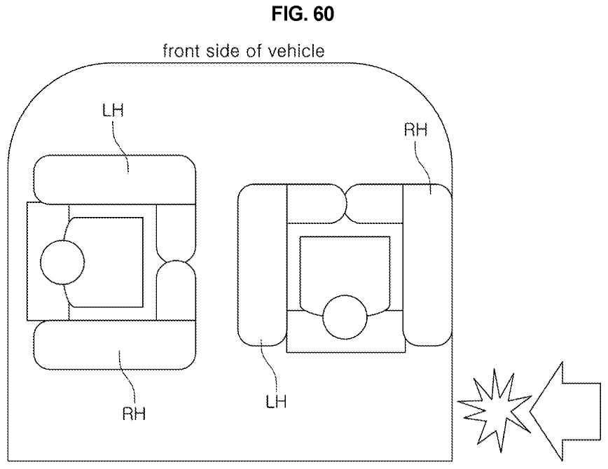

As another example, as illustrated in FIGS. 60 to 63, when a broadside collision accident occurs in the passenger seat direction in a state in which the left driver seat is turned at 90° toward the passenger seat and the passengers are respectively seated in the left driver seat and the right passenger seat, both the left and right airbag cushions LH and RH in the driver seat are simultaneously deployed.

Next, the controller C may perform control to deploy the left and right airbag cushions LH and RH in the seat directed toward the outside of the vehicle in the event of a broadside collision of the vehicle in case that the passengers are seated in the two opposite seats and the seat positioned in the direction opposite to the collision direction is directed toward the outside of the vehicle.

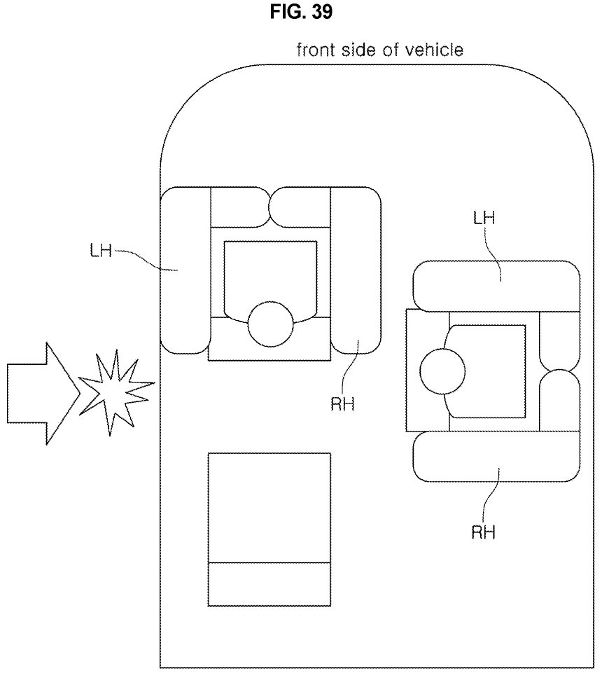

For example, as illustrated in FIGS. 39, 43, 47, and 51, when a broadside collision accident occurs in the driver seat direction in a state in which the right passenger seat is turned at 270° in the direction facing away from the driver seat and the passengers are respectively seated in the left driver seat and the right passenger seat, both the left and right airbag cushions LH and RH in the passenger seat are simultaneously deployed.

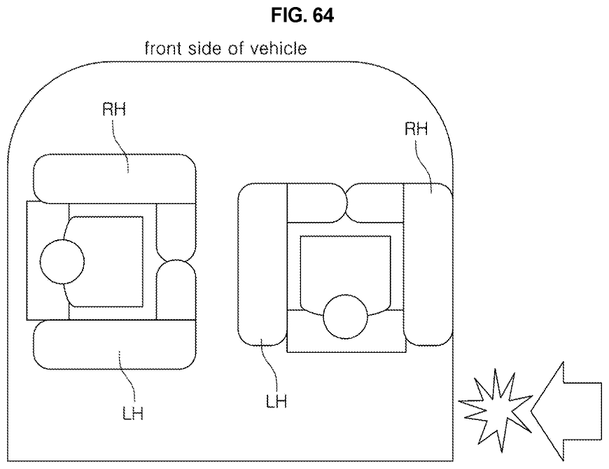

As another example, as illustrated in FIGS. 64 to 67, when a broadside collision accident occurs in the passenger seat direction in a direction in which the left driver seat is turned at 270° in the direction facing away from the passenger seat and the passengers are respectively seated in the left driver seat and the right passenger seat, both the left and right airbag cushions LH and RH in the driver seat are simultaneously deployed.

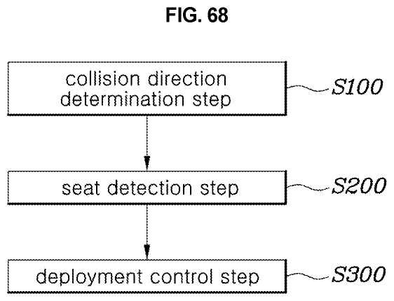

Meanwhile, with reference to FIG. 68, an airbag deployment control method of the present disclosure includes: a collision direction determination step S100 of detecting, by the controller C, the collision direction in the event of a collision of the vehicle; a seat detection step S200 of detecting, by the controller C, whether the passenger is seated in the seat and the seat direction; and a deployment control step S300 of controlling, by the controller C, the airbag cushions LH and RH, which are provided for each of the seats and configured to be deployed in the shapes that cover the lateral surface and the front surface of the seat at the left and right sides of the seat, to selectively deploy the airbag cushions LH and RH depending on the collision direction of the vehicle, whether the passenger is seated in the seat, and the seat direction.

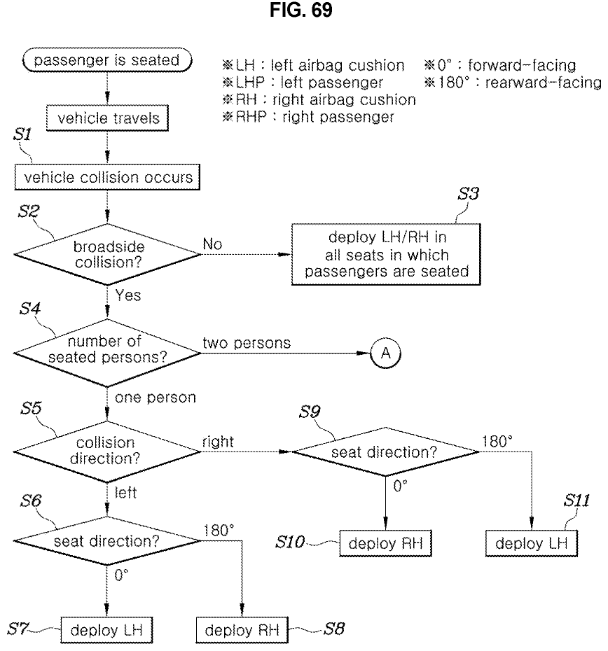

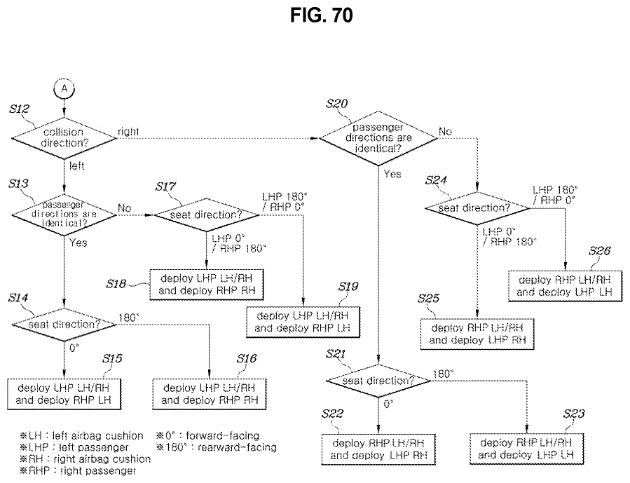

Hereinafter, airbag deployment control processes according to the present disclosure will be exemplarily described with reference to FIGS. 69 and 70.

When a collision accident occurs (S1) while the vehicle travels, the collision direction is determined (S2).

In case that the determination result in step S2 indicates that the collision accident is a head-on collision or a frontal broadside (oblique) collision, the left and right airbag cushions LH and RH of all the seats in which the passengers are seated are simultaneously deployed (S3).

In contrast, the determination result in step S2 indicates that the collision accident is a broadside collision, whether the passengers are seated in the left driver seat and the right passenger seat based on a first seat row is determined S4. For reference, in the case of a second seat row and the like, whether the left and right passengers are seated is determined in the same way as the first seat row, and an airbag deployment control logic may be performed.

In case that the determination result in step S4 indicates a one-passenger seated state in which the passenger is seated in the left driver seat and no passenger is seated in the right passenger seat, whether the collision direction is the driver seat direction or the passenger seat direction is determined (S5).

In case that the determination result in step S5 indicates that a broadside collision occurs in the driver seat direction, the direction in which the driver seat is directed is determined (S6).

In case that the determination result in step S6 indicates the forward-facing mode in which the driver seat is directed forward, only the left airbag cushion LH in the driver seat is deployed (S7).

In contrast, in case that the determination result in step S6 indicates the rearward-facing mode in which the driver seat is directed rearward, only the right airbag cushion RH in the driver seat is deployed (S8).

Meanwhile, in case that the determination result in step S5 indicates that a broadside collision occurs in the passenger seat direction, the direction in which the driver seat is directed is determined (S9).

In case that the determination result in step S9 indicates the forward-facing mode in which the driver seat is directed forward, only the right airbag cushion RH in the driver seat is deployed (S10).

In contrast, in case that the determination result in step S9 indicates the rearward-facing mode in which the driver seat is directed rearward, only the left airbag cushion LH in the driver seat is deployed (S11).

Meanwhile, in case that the determination result in step S4 indicates a two-passenger seated state in which the passengers are seated in the left driver seat and the right passenger seat, whether the collision direction is the driver seat direction or the passenger seat direction is determined (S12).

In case that the determination result in step S12 indicates that a left broadside collision occurs in the driver seat direction, whether the direction in which the driver seat is directed and the direction in which the passenger seat is directed are identical to each other is determined (S13).

In case that the determination result in step S13 indicates that the direction in which the driver seat is directed and the direction in which the passenger seat is directed are identical to each other, the direction in which the driver seat is directed and the direction in which the passenger seat is directed are determined (S14).

In case that the determination result in step S14 indicates the forward-facing mode in which the driver seat and the passenger seat are directed forward, both the left and right airbag cushions LH and RH in the left driver seat are deployed, and only the left airbag cushion LH in the right passenger seat is deployed (S15).

In contrast, in case that the determination result in step S14 indicates the rearward-facing mode in which the driver seat and the passenger seat are directed rearward, both the left and right airbag cushions LH and RH in the left driver seat are deployed, and only the right airbag cushion RH in the right passenger seat is deployed (S16).

Meanwhile, in case that the determination result in step S13 indicates that the direction in which the driver seat is directed and the direction in which the passenger seat is directed are not identical to each other, the direction in which the driver seat is directed and the direction in which the passenger seat is directed are determined (S17).

In case that the determination result in step S17 indicates the forward-facing mode in which the driver seat is directed forward and the rearward-facing mode in which the passenger seat is directed rearward, both the left and right airbag cushions LH and RH in the left driver seat are deployed, and only the right airbag cushion RH in the right passenger seat is deployed (S18).

In contrast, in case that the determination result in step S17 indicates the rearward-facing mode in which the driver seat is directed rearward and the forward-facing mode in which the passenger seat is directed forward, both the left and right airbag cushions LH and RH in the left driver seat are deployed, and only the left airbag cushion LH in the right passenger seat is deployed (S19).

Meanwhile, in case that the determination result in step S12 indicates that a right broadside collision occurs in the passenger seat direction, whether the direction in which the driver seat is directed and the direction in which the passenger seat is directed are identical to each other is determined (S20).

In case that the determination result in step S20 indicates that the direction in which the driver seat is directed and the direction in which the passenger seat is directed are identical to each other, the direction in which the driver seat is directed and the direction in which the passenger seat is directed are determined (S21).

In case that the determination result in step S21 indicates the forward-facing mode in which the driver seat and the passenger seat are directed, both the left and right airbag cushions LH and RH in the right passenger seat are deployed, and only the right airbag cushion RH in the left driver seat is deployed (S22).

In contrast, in case that the determination result in step S21 indicates the rearward-facing mode in which the driver seat and the passenger seat are directed rearward, both the left and right airbag cushions LH and RH in the right passenger seat are deployed, and only the right airbag cushion RH in the left driver seat is deployed (S23).

Meanwhile, in case that the determination result in step S20 indicates that the direction in which the driver seat is directed and the direction in which the passenger seat is directed are not identical to each other, the direction in which the driver seat is directed and the direction in which the passenger seat is directed are determined (S24).

In case that the determination result in step S24 indicates the forward-facing mode in which the driver seat is directed forward and the rearward-facing mode in which the passenger seat is directed rearward, both the left and right airbag cushions LH and RH in the right passenger seat are deployed, and only the right airbag cushion RH in the left driver seat is deployed (S25).

In contrast, in case that the determination result in step S24 indicates the rearward-facing mode in which the driver seat is directed rearward and the forward-facing mode in which the passenger seat is directed forward, both the left and right airbag cushions LH and RH in the right passenger seat are deployed, and only the left airbag cushion LH in the left driver seat is deployed (S26).

As described above, according to the present disclosure, the left and right airbag cushions LH and RH in the seat in which the passenger is seated are selectively deployed depending on the collision direction of the vehicle and the seat direction, which makes it possible to cope with various collision modes and safely protect the passenger.

In particular, in case that the passengers are seated at the left and right sides in a broadside collision situation, at least one of or both the airbag cushions LH and RH are deployed between the left seat and the right sear, thereby preventing a collision between the passengers and more safely protecting the passengers.

Moreover, the airbag of the present disclosure may be substituted for airbags in other portions, such that the number of types of airbags may be reduced, which prevents increases in costs and weight caused by the addition of airbags.

While the present disclosure has been described with reference to the specific examples, it is apparent to those skilled in the art that various modifications and alterations may be made within the technical spirit of the present disclosure, and these modifications and alterations belong to the appended claims.

What is claimed is:

1. An airbag deployment control system comprising:
a plurality of airbag cushions provided for a seat, the plurality of airbag cushions configured to be deployed in shapes that cover a lateral surface and a front surface of the seat at left and right sides of the seat; and
a controller configured to perform control to selectively deploy at least one of a left or right airbag cushion among the plurality of airbag cushions for the seat depending on a collision direction of a vehicle, whether a passenger is seated in the seat, and a seat direction.

2. The airbag deployment control system of claim 1, further comprising an additional seat and an additional plurality of airbag cushions configured to be deployed with respect to the additional seat.

3. The airbag deployment control system of claim 1, wherein the vehicle includes a plurality of seats, each of the seats having a respective plurality of airbag cushions arranged with respect to a respective one of the plurality of seats.

4. The airbag deployment control system of claim 1, wherein the controller performs control to deploy the left and right airbag cushions in the seat in which the passenger is seated in the event of a head-on collision of the vehicle regardless of the seat direction.

5. The airbag deployment control system of claim 1, wherein the controller performs control to deploy the left and right airbag cushions in the seat in which the passenger is seated in the event of a frontal broadside oblique collision of the vehicle regardless of the seat direction.

6. The airbag deployment control system of claim 1, wherein the controller performs control to deploy only the plurality of airbag cushions in the seat in which the passenger is seated and to selectively deploy the left and right airbag cushions depending on the collision direction and the direction of the seat in which the passenger is seated when the passenger is seated only in one side seat in the event of a broadside collision of the vehicle.

7. The airbag deployment control system of claim 1, wherein the controller performs control to deploy only the plurality of airbag cushions in a direction in which a collision occurs among the left and right airbag cushions in the seat in which the passenger is seated in the event of a broadside collision of the vehicle when the passenger is seated only in one side seat and the direction of the seat in which the passenger is seated is directed forward or rearward.

8. The airbag deployment control system of claim 1, wherein the controller performs control to deploy the right airbag cushion in the event of a broadside collision of the vehicle when the passenger is seated only in one side seat, the direction of the seat in which the passenger is seated is directed toward the inside of the vehicle, and the collision occurs in one direction.

9. The airbag deployment control system of claim 1, wherein the controller performs control to deploy the left airbag cushion in the event of a broadside collision of the vehicle when the passenger is seated only in one side seat, the direction of the seat in which the passenger is seated is directed toward the inside of the vehicle, and the collision occurs in the other direction.

10. The airbag deployment control system of claim 1, wherein the controller performs control to deploy the left and right airbag cushions in the seat in which the passenger is seated in the event of a broadside collision of the vehicle when the passenger is seated only in one side seat and the direction of the seat in which the passenger is seated is directed toward the outside of the vehicle.

11. The airbag deployment control system of claim 1, wherein the controller performs control to deploy the left and right airbag cushions in the seat positioned in the collision direction regardless of the seat direction when the passengers are seated in two opposite seats in the event of a broadside collision of the vehicle.

12. The airbag deployment control system of claim 1, wherein the controller performs control to deploy only the plurality of airbag cushions in the collision direction among the left and right airbag cushions in the seats positioned in a direction opposite to the collision direction in the event of a broadside collision of the vehicle when the passengers are seated in two opposite seats and the seat positioned in the opposite direction is directed forward or rearward.

13. The airbag deployment control system of claim 1, wherein the controller performs control to deploy the left and right airbag cushions in the seat directed toward the inside of the vehicle in the event of a broadside collision of the vehicle when the passengers are seated in two opposite seats and the seat positioned in a direction opposite to the collision direction is directed toward the inside of the vehicle.

14. The airbag deployment control system of claim 1, wherein the controller performs control to deploy the left and right airbag cushions in the seat directed toward the outside of the vehicle in the event of a broadside collision of the vehicle when the passengers are seated in two opposite seats and the seat positioned in a direction opposite to the collision direction is directed toward the outside of the vehicle.

15. A vehicle comprising the airbag deployment control system of claim 1.

16. An airbag deployment control method comprising:
a collision direction determination step of detecting, by a controller, a collision direction in the event of a collision of a vehicle;
a seat detection step of detecting, by the controller, whether a passenger is seated in a seat and a seat direction; and
a deployment control step of controlling, by the controller, a plurality of airbag cushions, which are provided for the seat and configured to be deployed in shapes that cover a lateral surface and a front surface of the seat at left or right sides of the seat, to selectively deploy at least one of the plurality of airbag cushions depending on a collision direction of the vehicle, whether the passenger is seated in the seat, and the seat direction.

17. The airbag deployment control method of claim 16, wherein the plurality of airbag cushions include at least one of a left or right airbag cushion among the plurality of airbag cushions.

18. The airbag deployment control method of claim 16, further comprising an additional seat and an additional plurality of airbag cushions configured to be deployed with respect to the additional seat.

19. The airbag deployment control method of claim 16, wherein the vehicle includes a plurality of seats, each of the seats having a respective plurality of airbag cushions arranged with respect to a respective one of the plurality of seats.

20. A non-transitory computer readable medium containing program instructions executed by a processor, the computer readable medium comprising:
program instructions that detect a collision direction in the event of a collision of a vehicle;
program instructions that detect whether a passenger is seated in a seat and a seat direction; and
program instructions that control a plurality of airbag cushions, which are provided for the seat and configured to be deployed in shapes that cover a lateral surface and a front surface of the seat at left or right sides of the seat, to selectively deploy at least one of the plurality of airbag cushions depending on a collision direction of the vehicle, whether the passenger is seated in the seat, and the seat direction.
